(19) United States
(12) Patent Application Publication
(10) Pub. No.: US 2009/0098430 A1
(43) Pub. Date: Apr. 16, 2009

(54) MEMBRANE-ELECTRODE ASSEMBLIES AND LONG-LIFE FUEL CELLS

(76) Inventors: Oemer Uensal, Mainz (DE); Joerg Belack, Oberhausen (DE); Ivan Schopov, Sofia (BG); Vesselin Sinigersky, Sofia (BG); Hhristo Bratschkov, Sofia (BG); Stoicho Schenkov, Sofia (BG)

Correspondence Address: CONNOLLY BOVE LODGE & HUTZ, LLP, P O BOX 2207, WILMINGTON, DE, 19899, US

(21) Appl. No.: 12/092,023

(22) PCT Filed: Oct. 28, 2006
(86) PCT No.: PCT/EP06/10389

§ 371 Date: Dec. 17, 2008

(30) Foreign Application Priority Data
Oct. 31, 2005 (DE) 102005052378.1

(51) Int. Cl. H01M 8/10; C08F 30/02; C08L 43/02; C08F 28/02

(52) U.S. Cl. 429/29; 526/218.1; 525/55; 525/340

(57) ABSTRACT

Polymer with high molecular weight which can be obtained by a method, in which a composition is polymerised by free-radical polymerisation which, based on its total weight, comprises at least 80.0% by weight of ethylenically unsaturated compounds, characterized in that the composition contains at least one monomer comprising phosphonic acid groups and/or sulphonic acid groups.

The polymer has a weight average of the degree of polymerisation of more than 300 and due to its chemical and physical properties, is particularly suitable for polymer electrolyte membranes (PEM) in so-called PEM fuel cells.

The present invention relates to vinylphosphonic acid polymers and vinylsulphonic acid polymers with a high molecular weight which can, owing to their excellent chemical and physical properties, be used for a variety of purposes and are particularly suitable for polymer electrolyte membranes (PEM) in so-called PEM fuel cells.

A fuel cell usually contains an electrolyte and two electrodes separated by the electrolyte. In the case of a fuel cell, one of the two electrodes is supplied with a fuel, such as hydrogen gas or a methanol-water mixture, and the other electrode is supplied with an oxidant, such as oxygen gas or air, and through this, chemical energy from the fuel oxidation is directly converted into electric energy. Protons and electrons are formed in the oxidation reaction.

The electrolyte is permeable to hydrogen ions, i.e. protons, but not for reactive fuels, such as the hydrogen gas or methanol and the oxygen gas.

As the tappable voltage of an individual fuel cell is relatively low, in general, several membrane electrode assemblies are connected in series and connected to each other via planar separator plates (bipolar plates).

As electrolyte for the fuel cell, solids, such as polymer electrolyte membranes, or liquids, such as phosphoric acid; are applied. Polymer electrolyte membranes have recently attracted interest as electrolytes for fuel cells. In principle, it is possible to differentiate between 2 categories of polymer membranes.

The first category includes cation exchange membranes consisting of a polymer frame which includes covalently attached acid groups. Currently, sulphonic acid-modified polymers are almost exclusively used in practice as proton-conducting membranes. Here, predominantly perfluorinated polymers are used. Nation™ from DuPont de Nemours, Wilimington, USA is a prominent example of this. For the conduction of protons, a relatively high water content is required in the membrane, which typically amounts to 4-20 molecules of water per sulphonic acid group. The required water content, but also the stability of the polymer in connection with acidic water and the reaction gases hydrogen and oxygen usually restrict the operating temperature of the PEM fuel cell stacks to 80-100° C. Under pressure, the operating temperatures can be increased to >120° C. Otherwise, higher operating temperatures can not be realised without a loss of power in the fuel cell.

Due to system-specific reasons, however, operating temperatures in the fuel cell of more than 100° C. are desirable. The activity of the catalysts based on noble metals and contained in the membrane electrode assembly (MEA) is significantly improved at high operating temperatures. Especially when the so-called reformates from hydrocarbons are used, the reformer gas contains considerable amounts of carbon monoxide which usually have to be removed by means of an elaborate gas conditioning or gas purification process. The tolerance of the catalysts to the CO impurities is increased at high operating temperatures.

Furthermore, heat is produced during operation of fuel cells. However, the cooling of these systems to less than 80° C. can be very complex. Depending on the power output, the cooling devices can be constructed significantly less complex. This means that the waste heat in fuel cell systems that are operated at temperatures of more than 100° C. can be utilised distinctly better and therefore the efficiency of the fuel cell system via combined power and heat generation can be increased.

To achieve these temperatures, the membranes of the second category have been developed which are based on complexes of alkaline polymers and strong acids and show ionic conductivity when employing water. The first promising development in this direction is set forth in the document WO96/13872.

An essential advantage of such a membrane doped with acid is the fact that a fuel cell in which such a polymer electrolyte membrane is employed can be operated at temperatures above 100° C. without the humidification of the fuels otherwise necessary.

Further advantages for the fuel cell system are achieved through this. On the one hand, the sensitivity of the platinum catalyst to gas impurities, in particular carbon monoxide, is reduced substantially. Furthermore, the efficiency of the fuel cell is increased through the high operating temperature.

It is disadvantageous that the acid, typically phosphoric acid or polyphosphoric acid, is not permanently bound to the alkaline polymer and can be washed out by water, in particular at operating temperatures below 100° C., e.g., when starting and shutting down the cell. This can lead to a permanent loss of the conductivity and the cell power which reduces the service life of the fuel cell.

Furthermore, such membranes are not suitable for direct methanol fuel cells (DMFC) as the electrolyte is constantly washed out during the required direct contact of the membrane doped with acid with the fuel mixture (methanol-water) which leads to an irreversible power drop.

To solve these problems, WO 03/07538 suggests using a polymer membrane which is obtained by polymerisation of vinyl-containing phosphonic acid in the presence of a preferably alkaline polymer. In this connection, the degree of polymerisation of the polyvinylphosphonic acid is preferably higher than 100.

Although washing out of the electrolyte is reduced considerably in this way and therefore the service life of the fuel cell is improved significantly, there is still demand for a further improvement of the service life of the fuel cell.

Therefore, it was an object of the present invention to provide a novel polymer electrolyte membrane in which it is avoided as good as possible that the electrolyte is washed out and the mechanical stability of the membrane is improved further. In this connection, the membrane should be suited for the production of fuel cells with the following properties:
The fuel cells should have a service life as long as possible.
It should be possible to employ the fuel cells in a range of operating temperatures (above and below 100° C.), in particular above 100° C., as wide as possible.
In operation, the individual cells should exhibit a constant or improved performance over a period, which should be as long as possible.
After a long operating time, the fuel cells should have an open circuit voltage as high as possible as well as a gas crossover as low as possible. Furthermore, it should be possible to operate them with a stoichiometry as low as possible.
At temperatures above 100° C., the fuel cells should manage to do without additional humidification of the fuel gas, if possible.
The fuel cells should be able to withstand permanent or alternate pressure differences between anode and cathodes as good as possible.
In particular, the fuel cells should be robust to different operating conditions (T, p, geometry, etc.) to increase the general reliability as good as possible.
Furthermore, the fuel cells should have an improved temperature and corrosion resistance and a relatively low gas permeability, in particular at high temperatures. A decline of the mechanical stability and the structural integrity, in particular at high temperatures, should be avoided as good as possible.
It should be possible to produce the fuel cells in a simple manner, on a large scale and inexpensive.

These and other objects not explicitly stated which can be derived from the description of the prior art set forth above are achieved by the use of a polymer with all the features of Claim 13. In the following, this polymer is sometimes called polymer (A).

Accordingly, an object of the present invention is a method for the production of a polymer with a high molecular weight, in which a composition is polymerised by free-radical polymerisation which, based on its total weight, comprises at least 80.0% by weight of ethylenically unsaturated compounds, wherein the composition contains at least one monomer comprising phosphonic acid groups and/or sulphonic acid groups.

Furthermore, the present invention relates to a polymer with a weight average of the degree of polymerisation of more than 300 which is obtained in accordance to the method according to the invention as well as to a membrane electrode assembly which includes two electrochemically active electrodes (anode and cathode) which are separated by a polymer electrolyte membrane, wherein the polymer electrolyte membrane comprises at least one polymer according to the invention.

The polymer according to the invention is characterized by a relatively high molecular weight. The weight average of the degree of polymerisation thereof is more than 300, preferably more than 500, conveniently more than 1000, in particular more than 1500. It can be determined in a manner known per se, wherein static light scattering has very particularly proven to be advantageous in this connection. Alternatively, the degree of polymerisation can also be determined by GPC methods.

The polymer according to the invention preferably has a wide molecular weight distribution, the polydispersity M_{w}/Mₙ thereof is conveniently in the range of 1 to 20, particularly preferably in the range of 3 to 10.

Furthermore, the polymer according to the invention preferably features an inherent viscosity (Staudinger index) of more than 1.0 dl/g, conveniently more than 5.0 dl/g, in particular more than 10.0 dl/g, each measured as a 0.4% by weight solution at 25° C.

The preparation of the polymer according to the invention is preferably performed by free-radical polymerisation of a composition which, based on its total weight, comprises at least 80.0% by weight, preferably at least 85.0% by weight, particularly preferably at least 90.0% by weight, in particular at least 95.0% by weight, of ethylenically unsaturated compounds and contains at least one monomer comprising phosphonic acid groups and/or sulphonic acid groups.

Monomers comprising phosphonic acid groups are known in professional circles. These are compounds having at least one carbon-carbon double bond and at least one phosphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the context of the present invention, the polymer containing phosphonic acid groups results from the polymerisation product which is obtained by polymerising the monomer containing phosphonic acid groups alone or with other monomers and/or crosslinkers.

The monomer comprising phosphonic acid groups may comprise one, two, three or more carbon-carbon double bonds. Furthermore, the monomer comprising phosphonic acid groups can contain one, two, three or more phosphonic acid groups.

Generally, the monomer comprising phosphonic acid groups contains 2 to 20, preferably 2 to 10, carbon atoms.

The monomer comprising phosphonic acid groups is preferably a compound of the formula

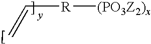

wherein
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,

Z represents, independently of another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10
y represents an integer 1, 2, 3, 4, 5, 6, 7, 8, 9 or 10
   and/or of the formula

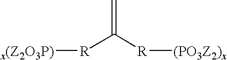

wherein
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,
Z represents, independently of another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10
   and/or of the formula

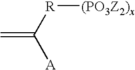

wherein
A represents a group of the formulae COOR², CN, CONR²₂, OR² and/or R²,
R² is hydrogen, a C1-C15 alkyl group, a C1-C15 alkoxy group, for example an ethyleneoxy group, or a C5-C20 aryl or heteroaryl group, wherein the above-mentioned radicals themselves can be substituted with halogen, —OH, COOZ, —CN, NZ₂,
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,
Z represents, independently of another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10.

The preferred monomers comprising phosphonic acid groups include, inter alia, alkenes which contain phosphonic acid groups, such as ethenephosphonic acid, propenephosphonic acid, butenephosphonic acid; acrylic acid compounds and/or methacrylic acid compounds which contain phosphonic acid groups, such as for example 2-phosphonomethylacrylic acid, 2-phosphonomethylmethacrylic acid, 2-phosphonomethylacrylamide and 2-phosphonomethylmethacrylamide.

Commercially available vinylphosphonic acid (ethenephosphonic acid), such as it is available from the company Aldrich or Clariant GmbH, for example, is particularly preferably used. A preferred vinylphosphonic acid has a purity of more than 70%, in particular 90% and particularly preferably a purity of more than 97%.

The monomers comprising phosphonic acid groups can furthermore be employed in the form of derivatives which subsequently can be converted to the acid wherein the conversion to the acid can also take place in the polymerised state. These derivatives include in particular the salts, the esters, the amides and the halides of the monomers comprising phosphonic acid groups.

The composition to be employed according to the invention preferably comprises, based on its total weight, at least 20% by weight, in particular at least 30% by weight and particularly preferably at least 50% by weight, of monomers comprising phosphonic acid groups.

According to a particular aspect of the present invention, compositions comprising monomers comprising sulphonic acid groups can be used to prepare the polymers comprising phosphonic acid groups and/or ionomers comprising phosphonic acid groups. In this connection, the weight ratio of monomers comprising sulphonic acid groups to monomers comprising phosphonic acid groups is preferably in the range of 100:1 to 1:100, preferably in the range of 10:1 to 1:10 and particularly preferably in the range of 2:1 to 1:2.

Monomers comprising sulphonic acid groups are known in professional circles. These are compounds having at least one carbon-carbon double bond and at least one sulphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the context of the present invention, the polymer comprising sulphonic acid groups results from the polymerisation product which is obtained by polymerising the monomer comprising sulphonic acid groups alone or with other monomers and/or crosslinkers.

The monomer comprising sulphonic acid groups may comprise one, two, three or more carbon-carbon double bonds. Furthermore, the monomer comprising sulphonic acid groups can contain one, two, three or more sulphonic acid groups.

Generally, the monomer comprising sulphonic acid groups contains 2 to 20, preferably 2 to 10, carbon atoms.

The monomer comprising sulphonic acid groups is preferably a compound of the formula

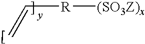

wherein
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,
Z represents, independently of another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10
y represents an integer 1, 2, 3, 4, 5, 6, 7, 8, 9 or 10
   and/or of the formula

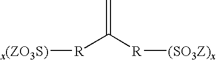

wherein
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,
Z represents, independently of another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10
   and/or of the formula

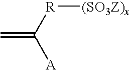

wherein
A represents a group of the formulae COOR², CN, CONR²₂, OR² and/or R²,
R² is hydrogen, a C1-C15 alkyl group, a C1-C15 alkoxy group, for example an ethyleneoxy group, or a C5-C20 aryl or heteroaryl group, wherein the above-mentioned radicals themselves can be substituted with halogen, —OH, COOZ, —CN, NZ₂,
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,
Z represents, independently of another, hydrogen, a C1-C15 alkylene group, a C1-C15 alkoxy group, for example ethyleneoxy group, or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10.

The preferred monomers comprising sulphonic acid groups include, inter alia, alkenes which contain sulphonic acid groups, such as ethenesulphonic acid, propenesulphonic acid, butenesulphonic acid; acrylic acid compounds and/or methacrylic acid compounds which contain sulphonic acid groups, such as for example 2-sulphonomethylacrylic acid, 2-sulphonomethylmethacrylic acid, 2-sulphonomethylacrylamide and 2-sulphonomethylmethacrylamide.

Commercially available vinylsulphonic acid (ethenesuiphonic acid), such as it is available from the company Aldrich or Clariant GmbH, for example, is particularly preferably used. A preferred vinylsulphonic acid has a purity of more than 70%, in particular 90% and particularly preferably a purity of more than 97%.

The monomers comprising sulphonic acid groups can furthermore be employed in the form of derivatives, which subsequently can be converted to the acid, wherein the conversion to the acid may also take place in the polymerised state. These derivatives include in particular the salts, esters, amides and halides of the monomers comprising sulphonic acid groups.

The composition to be employed according to the invention preferably comprises, based on its total weight, at least 20% by weight, in particular at least 30% by weight and particularly preferably at least 50% by weight, of monomers comprising sulphonic acid groups.

In a preferred embodiment of the invention, the polymerisable composition contains monomers capable of cross-linking. This are in particular compounds which have at least 2 carbon-carbon double bonds. Preference is given to dienes, trienes, tetraenes, dimethylacrylates, trimethylacrylates, tetramethylacrylates, diacrylates, triacrylates, tetraacrylates.

Particular preference is given to dienes, trienes, tetraenes of the formula

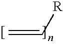

dimethylacrylates, trimethylacrylates, tetramethylacrylates of the formula

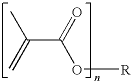

diacrylates, triacrylates, tetraacrylates of the formula

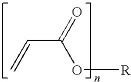

wherein
R represents a C1-C15 alkyl group, a C5-C20 aryl or heteroaryl group, NR′, —SO₂, PR′, Si(R′)₂, wherein the above-mentioned radicals themselves can be substituted,
R′ represents, independently of another, hydrogen, a C1-C15 alkyl group, a C1-C15 alkoxy group, a C5-C20 aryl or heteroaryl group, and
n is at least 2.

The substituents of the above-mentioned radical R are preferably halogen, hydroxyl, carboxy, carboxyl, carboxylester, nitrites, amines, silyl, siloxane radicals.

Particularly preferred cross-linking agents are allyl methacrylate, ethylene glycol dimethacrylate, diethylene glycol dimethacrylate, triethylene glycol dimethacrylate, tetraethylene glycol dimethacrylate and polyethylene glycol dimethacrylate, 1,3-butanediol dimethacrylate, glycerol dimethacrylate, diurethane dimethacrylate, trimethylpropane trimethacrylate, epoxy acrylates, for example ebacryl, N′,N-methylenebisacrylamide, carbinol, butadiene, isoprene, chloroprene, divinylbenzene and/or bisphenol A dimethylacrylate. These compounds are commercially available from Sartomer Company Exton, Pa. under the designations CN-120, CN104 and CN-980, for example.

The use of cross-linking agents is optional, wherein these compounds can typically be employed in the range of 0.05 and 30% by weight, preferably 0.1 to 20% by weight, particularly preferably 1 to 10% by weight, based on the weight of the monomers comprising phosphonic acid groups.

According to a very particularly preferred variant of the invention, however, the composition contains no cross-linking agents. The non-cross-linked polymers which can be obtained in this way can be processed further more easily.

The composition can additionally contain further components, in particular organic and/or inorganic solvents. The organic solvents include in particular polar aprotic solvents, such as dimethyl sulphoxide (DMSO), esters, such as ethyl acetate, and polar protic solvents, such as alcohols, such as ethanol, propanol, Isopropanol and/or butanol. The inorganic solvents include in particular water, phosphoric acid and polyphosphoric acid.

These may positively influence the processability of the resultant polymers. In particular, the solubility of the polymers can be improved by addition of the organic solvent.

Within the context of the present invention, the composition containing the monomers comprising phosphonic acid groups and/or sulphonic acid groups is polymerised by free-radical polymerisation, wherein the reaction is conveniently initiated thermally, photochemically, chemically and/or electrochemically.

For example, a starter solution containing at least one substance capable of forming radicals can be added to the composition. Furthermore, at least one radical former can also be added directly to the composition and dissolved in the composition by ultrasound, for example.

Suitable radical formers are, amongst others, azo compounds, peroxy compounds, persulphate compounds or azoamidines. Non-limiting examples are dibenzoyl peroxide, dicumene peroxide, cumene hydroperoxide, diisopropyl peroxydicarbonate, bis(4-t-butylcyclohexyl) peroxydicarbonate, dipotassium persulphate, ammonium peroxydisulphate, 2,2′-azobis(2-methylpropionitrile) (AIBN), 2,2′-azobis(isobutyric acid amidine)hydrochloride, benzopinacol, dibenzyl derivatives, methyl ethylene ketone peroxide, 1,1-azobiscyclohexanecarbonitrile, methyl ethyl ketone peroxide, acetyl acetone peroxide, dilauryl peroxide, didecanoyl peroxide, tert-butylper-2-ethyl hexanoate, ketone peroxide, methyl isobutyl ketone peroxide, cyclohexanone peroxide, dibenzoyl peroxide, tert-butylperoxybenzoate, tert-butylperoxyisopropylcarbonate, 2,5-bis(2-ethylhexanoylperoxy)-2,5-dimethylhexane, tert-butylperoxy-2-ethylhexanoate, tert.-butylperoxy-3,5,5-trimethylhexanoate, tert-butylperoxyisobutyrate, tert-butylperoxyacetate, dicumene peroxide, 1,1-bis(tert-butylperoxy)cyclohexane, 1,1-bis(tert-butylperoxy)-3,3,5-trimethylcyclohexane, cumyl hydroperoxide, tert-butylhydroperoxide, bis(4-tert-butylcyclohexyl) peroxydicarbonate, and the radical formers available from DuPont under the name ®Vazo, for example ®Vazo V50 and ®Vazo WS.

Furthermore, it is also possible to employ radical formers which form radicals with irradiation. The preferred compounds include, amongst others, α,α-diethoxyacetophenone (DEAP, Upjon Corp), n-butyl benzoin ether (®Trigonal-14, AKZO) and 2,2-dimethoxy-2-phenylacetophenone (®Igacure 651) and 1-benzoyl cyclohexanol (®Igacure 184) bis-(2,4,6-trimethylbenzoyl)phenylphosphine oxide (®Irgacure 819) and 1-[4-(2-hydroxyethoxy)phenyl]-2-hydroxy-2-phenylpropan-1-one (®Irgacure 2959) each of which is commercially available from the company Ciba Geigy Corp.

For the purposes of the present invention, the use of water-soluble radical formers has proven to be very particularly advantageous. These have a water solubility of at least 0.1 g, preferably of at least 0.5 g, in particular of at least 1.0 g, per 100 g of aqueous solution at 20° C. and pH=5.

Particularly beneficial is the use of the following radical formers from the company Dupont:

®Vazo 56WSW: 2,2′-azobis(2-amidinopropane) dihydrochloride
®Vazo 56WSP: 2,2′-azobis(2-methylpropionamidine) dihydrochloride
®Vazo 68WSP: 4,4′-azobis(4-cyanovaleric acid)
®Vazo 33: 2,2′-azobis(2,4-dimethyl-4-methoxypentanenitrile)
®Vazo 44WSP: 2,2′-azobis-(N,N′-diethyleneisobutylamidine) dihydrochloride
as well as from the company Wako:
®VA-041: 2,2′-azobis[2-(5-methyl-2-imidazolin-2-yl)propane]dihydrochloride
®VA-044: 2,2′-azobis[2-(2-imidazolin-2-yl)propane]dihydrochloride
®VA-046B: 2,2′-azobis[2-(2-imidazolin-2-yl)propane]disulfate dihydrate
®V-50: 2,2′-azobis(2-methylpropionamide) dihydrochlorides
®VA-057: 2,2′-azobis[N-(2-carboxyethyl)-2-methylpropionamidine]tetrahydrate
®VA-058: 2,2′-azobis[2-(3,4,5,6-tetrahydropyrimidin-2-yl)propane]dihydrochloride
®VA-060: 2,2′-azobis{2-[1-(2-hydroxyethyl)-2-imidazolin-2-yl]propane}dihydrochloride
®VA-061: 2,2′-azobis[2-(2-imidazolin-2-yl)propanes]
®VA-080: 2,2′-azobis[2-methyl-N-[1,1-bis(hydroxymethyl)-2-hydroxyethyl]propionamide
®VA-085: 2,2′-azobis{2-methyl-N-[2-(1-hydroxybutyl)]propionamide}
®VA-086: 2,2′-azobis[2-methyl-N-(2-hydroxyethyl)propionamide].

Under the chosen polymerisation conditions, the radical formers preferably have a half-life in the range of 1 minute to 300 minutes, preferably in the range of 1 minute to 200 minutes, in particular in the range of 1 minute to 150 minutes.

Typically, between 0.0001 and 5% by weight, in particular 0.01 to 3% by weight (based on the weight of the composition) of radical formers are added. The amount of radical former can be varied according to the degree of polymerisation desired.

The polymerisation can also take place by action of IR or NIR (IR=infrared, i.e. light having a wavelength of more than 700 nm; NIR=near-IR, i.e. light having a wavelength in the range of about 700 to 2000 nm and an energy in the range of about 0.6 to 1.75 eV), respectively.

The polymerisation can also take place by action of UV light having a wavelength of less than 400 nm. This polymerisation method is known per se and described, for example, in Hans Joerg Elias, Makromolekulare Chemie, 5th edition, volume 1, pp. 492-511; D. R. Arnold, N.C. Baird, J. R. Bolton, J. C. D. Brand, P. W. M Jacobs, P. de Mayo, W. R. Ware, Photochemistry—An Introduction, Academic Press, New York and M. K. Mishra, Radical Photopolymerization of Vinyl Monomers, J. Macromol. Sci.-Revs. Macromol. Chem. Phys. C22 (1982-1983) 409.

The polymerisation may also take place by exposure to β rays, γ rays and/or electron rays. According to a particular embodiment of the present invention, a membrane is irradiated with a radiation dose in the range of 1 to 300 kGy, preferably from 3 to 250 kGy and very particularly preferably from 20 to 200 kGy.

The polymerisation of the composition preferably takes place at temperatures above room temperature (20° C.) and below 200° C., in particular at temperatures between 40° C. and 150° C., particularly preferably between 50° C. and 120° C. The polymerisation preferably takes place at normal pressure, but may also take place under pressure.

The polymers according to the invention are particularly suitable for polymer electrolyte membranes (PEM) in so-called PEM fuel cells. In this connection, they can be used both alone and in combination with one or more polymers (B) which can not be obtained by polymerisation of monomers comprising phosphonic acid groups and/or sulphonic acid groups. In this connection, particularly suitable combinations of the polymers (A) and (B) have a weight ratio of polymer (A) to polymer (B) in the range of 1:1 to 10:1. Furthermore, the use of compositions which, based on their total weight, contain

a) 40.0 to 90.0% by weight of polymer (A)
b) 1.0 to 30.0% by weight of polymer (B) and
c) 0.0 to 50.0% by weight of phosphoric acid
have proven as particularly advantageous, wherein the weight proportions of the components preferably amount to 100.0% by weight. According to a first very particularly preferred embodiment of the invention, the composition comprises 70.0 to 90.0% by weight, preferably 75.0 to 85% by weight, of polymer (A) and 10.0 to 30.0% by weight, preferably 15.0 to 25.0% by weight, of polymer (B). According to a second very particularly preferred embodiment of the invention, the composition comprises 40.0 to 60.0% by weight, preferably 45.0 to 55% by weight, of polymer (A), 5.0 to 15.0% by weight, preferably 7.5 to 12.5% by weight, of polymer (B) and 30.0 to 50.0% by weight, preferably 35.0 to 45.0% by weight, of phosphoric acid (H₃PO₄).

The preferred polymers (B) include, amongst others, polyolefines, such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinyl amine, poly(N-vinyl acetamide), polyvinyl imidazole, polyvinyl carbazole, polyvinyl pyrrolidone, polyvinyl pyridine, polyvinyl chloride, polyvinylidene chloride, polytetrafluoroethylene, polyvinyl difluoride, polyhexafluoropropylene, polyethylenetetrafluoroethylene, copolymers of PTFE with hexafluoropropylene, with perfluoropropylvinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornenes;

polymers having C—O bonds in the backbone, for example
polyacetal, polyoxymethylene, polyether, polypropylene oxide, polyepichlorohydrin, polytetrahydrofuran, polyphenylene oxide, polyether ketone, polyether ether ketone, polyether ketone ketone, polyether ether ketone ketone, polyether ketone ether ketone ketone,
polyester, in particular polyhydroxyacetic acid, polyethyleneterephthalate, polybutyleneterephthalate, polyhydroxybenzoate, polyhydroxypropionic acid, polypropionic acid, polypivalolacton, polycaprolacton, furan resins, phenol aryl resins, polymalonic acid, polycarbonate;
polymeric C—S bonds in the backbone, for example polysulphide ether, polyphenylenesulphide, polyethersulphone, polysulphone, polyetherethersulphone, polyarylethersulphone, polyphenylenesulphone, polyphenylenesulphidesulphone, poly(phenylsuiphide)-1,4-phenylene;
polymers containing C—N bonds in the backbone, for example polyimines, polyisocyanides, polyetherimine, polyetherimides, poly(trifluoromethyl)bis(phthalimide)phenyl, polyaniline, polyaramides, polyamides, polyhydrazides, polyurethanes, polyimides, polyazoles, polyazole ether ketone, polyureas, polyazines;
liquid-crystalline polymers, in particular Vectra, and
inorganic polymers, for example polysilanes, polycarbosilanes, polysiloxanes, polysilicic acid, polysilicates, silicones, polyphosphazenes and polythiazyl. These polymers can be used individually or as a mixture of two, three or more polymers.

Particular preference is given to polymers containing at least one nitrogen atom, oxygen atom and/or sulphur atom in a repeating unit. Particularly preferred are polymers containing at least one aromatic ring with at least one nitrogen, oxygen and/or sulphur heteroatom per repeating unit. From this group, polymers based on polyazoles are particularly preferred. These alkaline polyazole polymers contain at least one aromatic ring with at least one nitrogen heteroatom per repeating unit.

The aromatic ring is preferably a five-membered or six-membered ring with one to three nitrogen atoms, which may be fused to another ring, in particular another aromatic ring.

In this connection, polyazoles are particularly preferred. Polymers based on polyazole generally contain recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

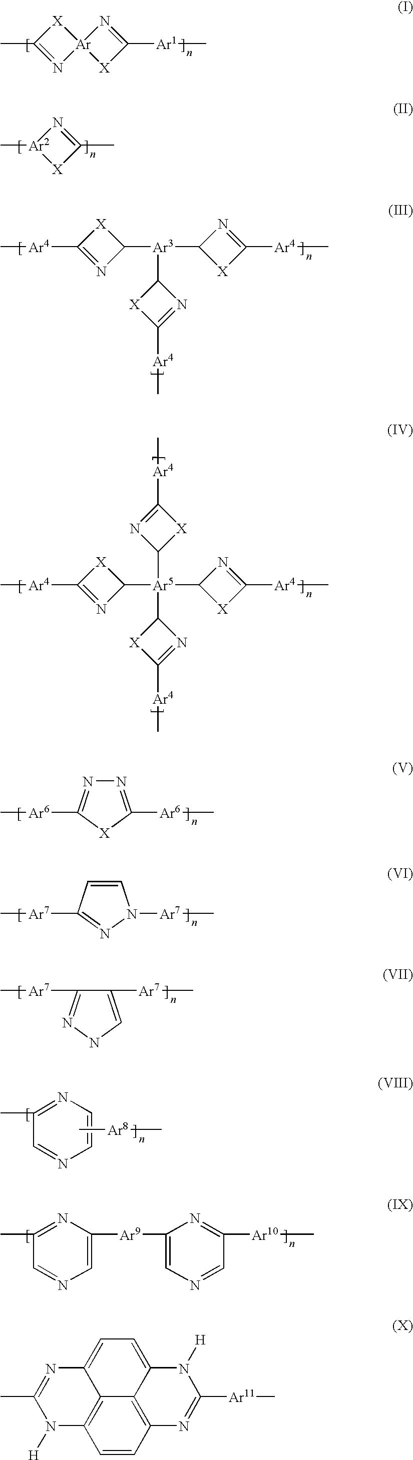

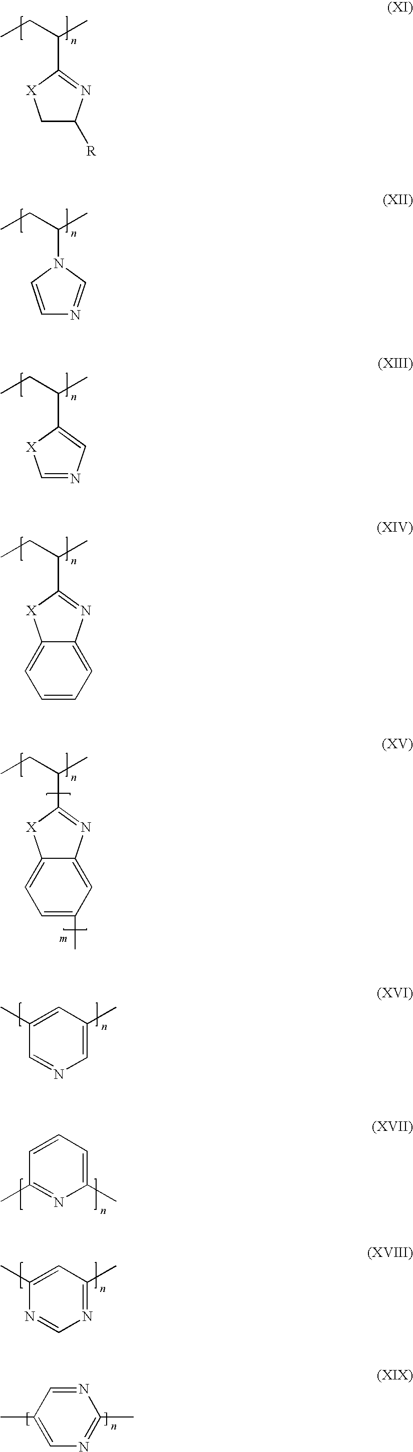

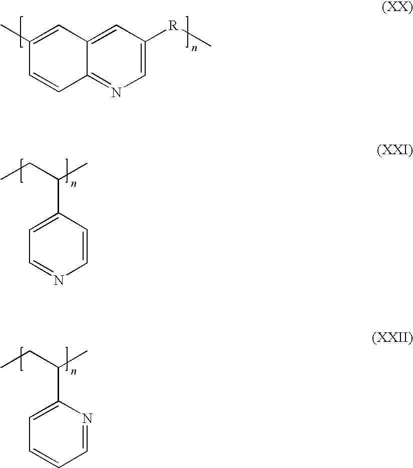

wherein
Ar are identical or different and represent a tetravalent aromatic or heteroaromatic group which can be mononuclear or polynuclear,
Ar¹ are identical or different and represent a divalent aromatic or heteroaromatic group which can be mononuclear or polynuclear,
Ar² are identical or different and represent a divalent or trivalent aromatic or heteroaromatic group which can be mononuclear or polynuclear,
Ar³ are identical or different and represent a trivalent aromatic or heteroaromatic group which can be mononuclear or polynuclear,
Ar⁴ are identical or different and represent a trivalent aromatic or heteroaromatic group which can be mononuclear or polynuclear,
Ar⁵ are identical or different and represent a tetravalent aromatic or heteroaromatic group which can be mononuclear or polynuclear,
Ar⁶ are identical or different and represent a divalent aromatic or heteroaromatic group which can be mononuclear or polynuclear,
Ar⁷ are identical or different and represent a divalent aromatic or heteroaromatic group which can be mononuclear or polynuclear,
Ar⁸ are identical or different and represent a trivalent aromatic or heteroaromatic group which can be mononuclear or polynuclear,
Ar⁹ are identical or different and represent a divalent or trivalent or tetravalent aromatic or heteroaromatic group which can be mononuclear or polynuclear,
Ar¹⁰ are identical or different and represent a divalent or trivalent aromatic or heteroaromatic group which can be mononuclear or polynuclear,
Ar¹¹ are identical or different and represent a divalent aromatic or heteroaromatic group which can be mononuclear or polynuclear,
X are identical or different and represent oxygen, sulphur or an amino group which carries a hydrogen atom, a group having 1-20 carbon atoms, preferably a branched or unbranched alkyl or alkoxy group, or an aryl group as a further radical,
R represent, identical or different, hydrogen, an alkyl group and an aromatic group, represents, identical or different, hydrogen, an alkyl group and an aromatic group, with the proviso that R in the formula XX is a divalent group, and
n, m are each an integer greater than or equal to 10, preferably greater than or equal to 100.

Preferred aromatic or heteroaromatic groups are derived from benzene, naphthalene, biphenyl, diphenyl ether, diphenylmethane, diphenyldimethylmethane, bisphenone, diphenylsulphone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzooxathiadiazole, benzooxadiazole, benzopyridine, benzopyrazine, benzopyrazidine, benzopyrimidine, benzotriazine, indolizine, pyridopyridine, imidazopyrimidine, pyrazinopyrimidine, carbazole, aziridine, phenazine, benzoquinoline, phenoxazine, phenothiazine, acridizine, benzopteridine phenanthroline and phenanthrene which optionally also can be substituted.

In this case, Ar¹, Ar⁴, Ar⁶, Ar⁷, Ar⁸, Ar⁹, Ar¹⁰, Ar¹¹ can have any substitution pattern, in the case of phenylene, for example, Ar¹, Ar⁴, Ar⁶, Ar⁷, Ar⁸, Ar⁹, Ar¹⁰, Ar¹¹ can be ortho-phenylene, meta-phenylene and para-phenylene. Particularly preferred groups are derived from benzene and biphenylene, which may also be substituted.

Preferred alkyl groups are short-chain alkyl groups having from 1 to 4 carbon atoms, such as, e.g., methyl, ethyl, n-propyl or i-propyl and t-butyl groups.

Preferred aromatic groups are phenyl or naphthyl groups. The alkyl groups and the aromatic groups can be substituted.

Preferred substituents are halogen atoms, such as, e.g., fluorine, amino groups, hydroxy groups or short-chain alkyl groups, such as, e.g., methyl or ethyl groups.

Preference is given to polyazoles having recurring units of the formula (I) in which the radicals X within a recurring unit are identical.

The polyazoles can in principle also have different recurring units wherein their radicals X are different, for example. However, there are preferably only identical radicals X in a recurring unit.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In another embodiment of the present invention, the polymer containing recurring azole units is a copolymer or a blend which contains at least two units of the formulae (I) to (XXII) which differ from one another. The polymers can be in the form of block copolymers (diblock, triblock), random copolymers, periodic copolymers and/or alternating polymers.

In a particularly preferred embodiment of the present invention, the polymer containing recurring azole units is a polyazole, which only contains units of the formulae (I) and/or (II).

The number of recurring azole units in the polymer is preferably an integer greater than or equal to 10. Particularly preferred polymers contain at least 100 recurring azole units.

Within the context of the present invention, preference is given to polymers containing recurring benzimidazole units. Some examples of the most appropriate polymers containing recurring benzimidazole units are represented by the following formulae:

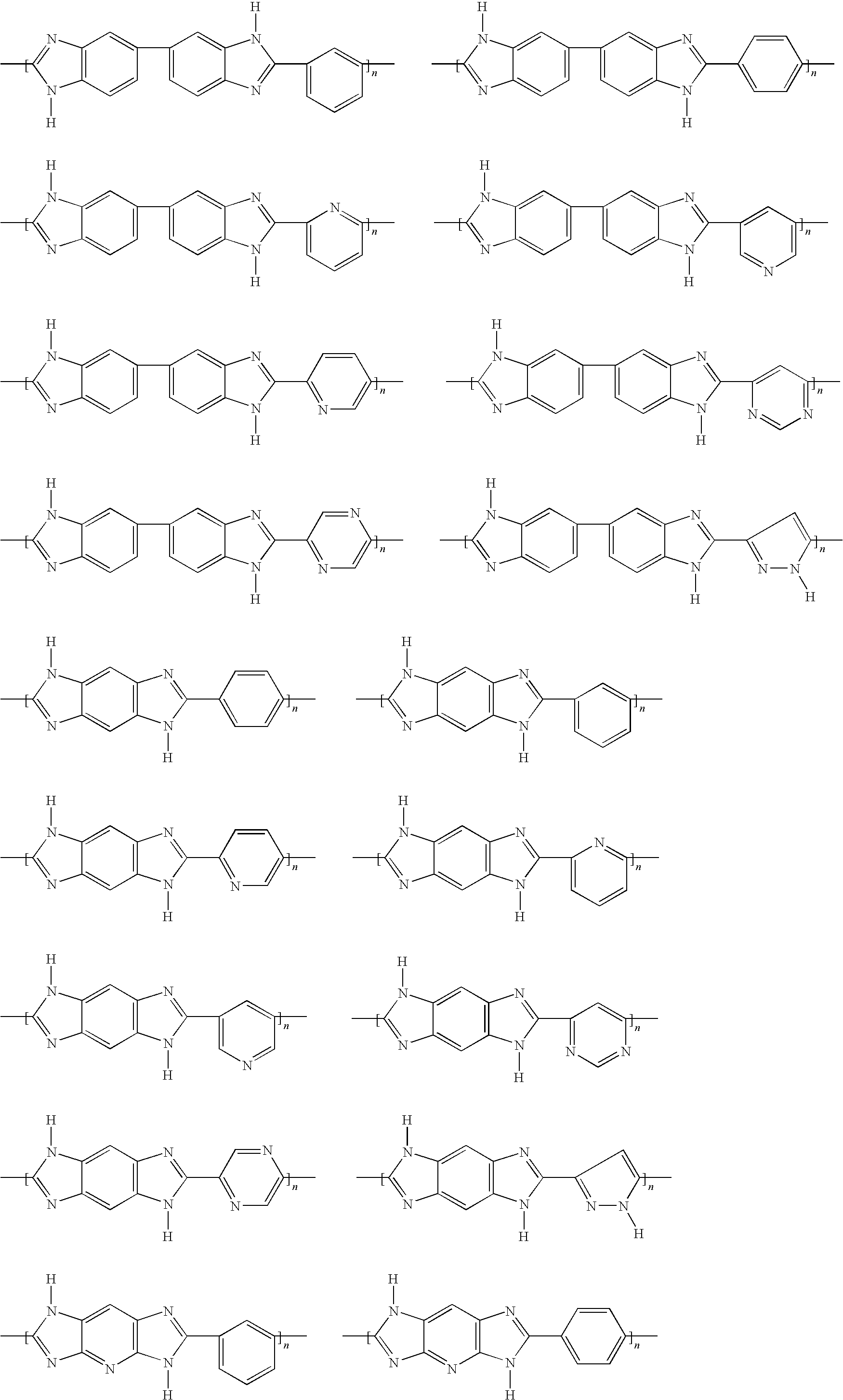

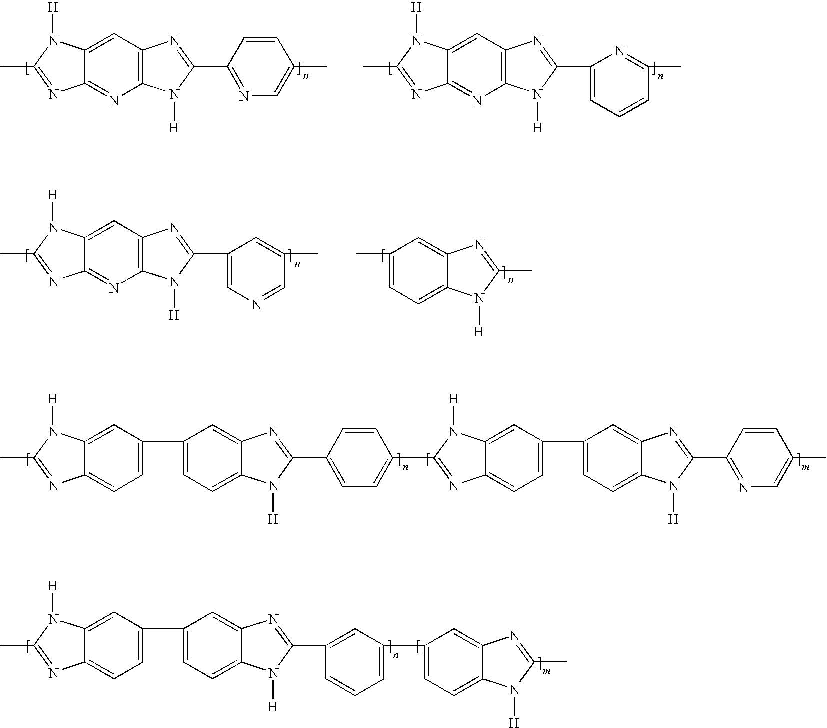

where n and m are each an integer greater than or equal to 10, preferably greater than or equal to 100.

Further preferred polyazole polymers are polyimidazoles, polybenzimidazole ether ketone, polybenzothiazoles, polybenzoxazoles, polytriazoles, polyoxadiazoles, polythiadiazoles, polypyrazoles, polyquinoxalines, poly(pyridines), poly(pyrimidines) and poly(tetrazapyrenes).

Preferred polyazoles are characterized by a high molecular weight. This applies in particular to the polybenzimidazoles. Measured as the intrinsic viscosity, this is preferably at least 0.2 dl/g, preferably 0.7 to 10 dl/g, in particular 0.8 to 5 dl/g.

Celazole from the company Celanese is particularly preferred. The properties of polymer film and polymer membrane can be improved by screening the starting polymer, as described in German patent application No. 10129458.1.

Furthermore, polymers with aromatic sulphonic acid groups can be used as polymer (B). Aromatic sulphonic acid groups are groups in which the sulphonic acid group (—SO₃H) is bound covalently to an aromatic or heteroaromatic group. The aromatic group may form part of the main chain (backbone) of the polymer or may form part of a side group, with preference being given to polymers containing aromatic groups in the main chain. The sulphonic acid groups can often also be used in the form of the salts. It is also possible to use derivatives, for example esters, in particular methyl or ethyl esters, or halides of sulphonic acids, which are converted into the sulphonic acid during operation of the membrane.

The polymers modified with sulphonic acid groups preferably have a content of sulphonic acid groups in the range of 0.5 to 3 meq/g, preferably 0.5 to 2.5. This value is determined through the so-called ion exchange capacity (IEC).

In order to measure the IEC, the sulphonic acid groups are converted into the free acid. To this end, the polymer is treated with acid in the known manner, with excess acid being removed by washing. For example, the sulphonated polymer is firstly treated in boiling water for 2 hours. Subsequently, excess water is dabbed off and the sample is dried at 160° C. in a vacuum drying cabinet at p<1 mbar for 15 hours. The dry weight of the membrane is then determined. The polymer dried in this way is then dissolved in DMSO at 80° C. over 1 h. Subsequently, the solution is titrated with 0.1M NaOH. The ion exchange capacity (IEC) is then calculated from the consumption of acid up to the equivalent point and the dry weight.

Polymers with sulphonic acid groups covalently bound to aromatic groups are known in professional circles. Polymers with aromatic sulphonic acid groups can, for example, be produced by sulphonation of polymers. Methods for the sulphonation of polymers are described in F. Kucera et al., Polymer Engineering and Science 1988, Vol. 38, No. 5, 783-792. Here, the sulphonation conditions can be selected such that a low degree of sulphonation is obtained (DE-A-19959289).

With regard to polymers having aromatic sulphonic acid groups whose aromatic radicals are part of the side group, particular reference shall be made to polystyrene derivatives. The document U.S. Pat. No. 6,110,616 for instance describes copolymers of butadiene and styrene and their subsequent sulphonation for use in fuel cells.

Such polymers can also be obtained by polyreactions of monomers which contain acid groups. For example, perfluorinated polymers as described in U.S. Pat. No. 5,422,411 can be produced by copolymerisation from trifluorostyrene and sulphonyl-modified trifluorostyrene.

According to a particular aspect of the present invention, thermoplastics stable at high temperatures, which include sulphonic acid groups bound to aromatic groups are employed. In general, such polymers have aromatic groups in the backbone. Thus, sulphonated polyether ketones (DE-A-4219077, WO96/01177), sulphonated polysulphones (J. Membr. Sci. 83 (1993), p. 211) or sulphonated polyphenylenesulphide (DE-A-19527435) are preferred.

The polymers set forth above which have sulphonic acid groups bound to aromatic groups can be used individually or as a mixture wherein mixtures having polymers with aromatic groups in the backbone are particularly preferred.

The preferred polymers include polysulphones, in particular polysulphone having aromatic groups in the backbone. According to a particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, to measured in accordance with ISO 1133.

According to a particular aspect of the present invention, the weight ratio of polymer with sulphonic acid groups covalently bound to aromatic groups to monomers comprising phosphonic acid groups can be in the range of 0.1 to 50, preferably from 0.2 to 20, particularly preferably from 1 to 10.

Preferred polymers include polysulphones, in particular polysulphone having aromatic and/or heteroaromatic groups in the backbone. According to a particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, measured in accordance with ISO 1133. Here, preference is given to polysulphones with a Vicat softening temperature VST/A/50 of 180° C. to 230° C. In yet another preferred embodiment of the present invention, the number average of the molecular weight of the polysulphones is greater than 30,000 g/mol.

The polymers based on polysulphone include in particular polymers having recurring units with linking sulphone groups according to the general formulae A, B, C, D, E, F and/or G:

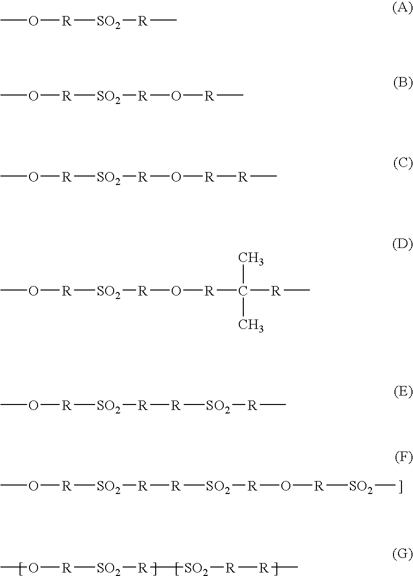

wherein the radicals R, independently of another, identical or different, represent aromatic or heteroaromatic groups, these radicals having been explained in detail above. These include in particular 1,2-phenylene, 1,3-phenylene, 1,4-phenylene, 4,4′-biphenyl, pyridine, quinoline, naphthalene, phenanthrene.

The polysulphones preferred within the context of the present invention include homopolymers and copolymers, for example random copolymers. Particularly preferred polysulphones comprise recurring units of the formulae H to N:

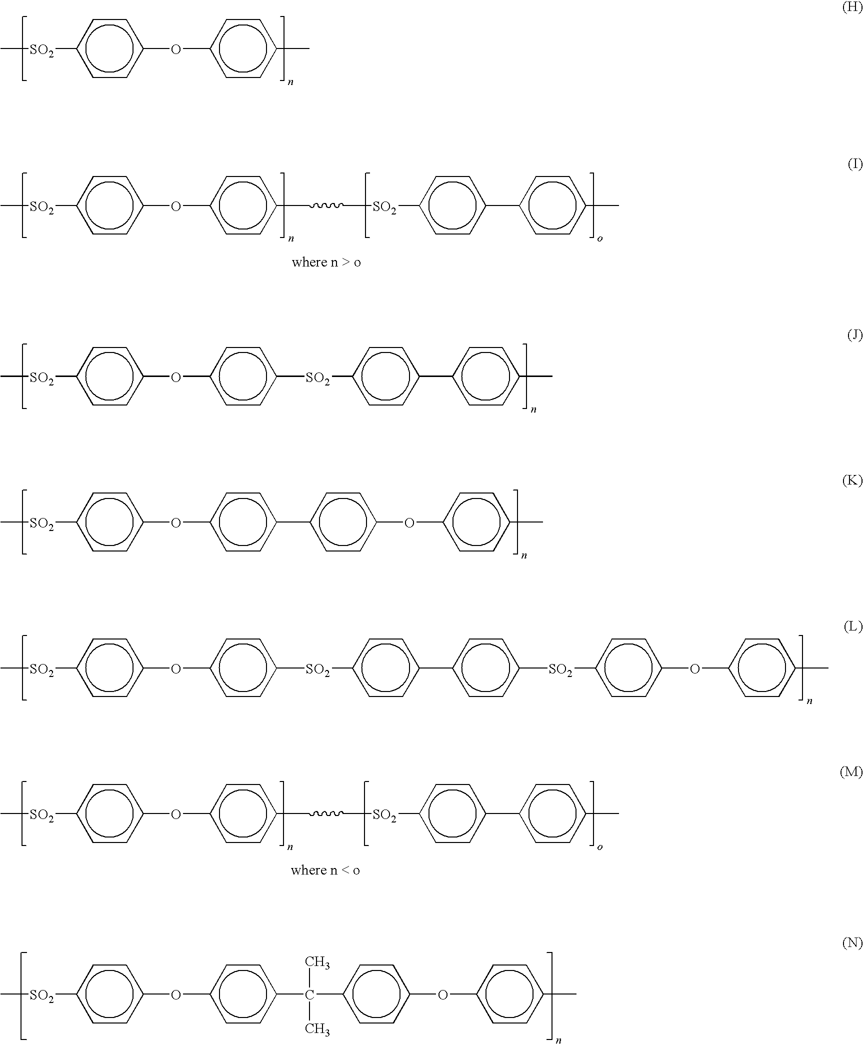

The previously described polysulphones can be obtained commercially under the trade names ®Victrex 200 P, ®Victrex 720 P, ®Ultrason E, ®Ultrason S, ®Mindel, ®Radel A, ®Radel R, ®Victrex HTA, ®Astrel and ®Udel.

Furthermore, polyether ketones, polyether ketone ketones, polyether ether ketones, polyether ether ketone ketones and polyaryl ketones are particularly preferred. These high-performance polymers are known per se and can be obtained commercially under the trade names Victrex® PEEK™, ®Hostatec, ®Kadel.

In order to further improve the technical properties, it is also possible for fillers, in particular proton-conducting fillers, and additional acids to be added to the membrane. Such substances preferably have an intrinsic conductivity of at least 10⁻⁶ S/cm, in particular 10⁻⁵ S/cm at 100° C.

Non-limiting examples of proton-conducting fillers are sulphates, in particular CsHSO₄, Fe(SO₄)₂, (NH₄)₃H(SO₄)₂, LiHSO₄, NaHSO₄, KHSO₄, RbSO₄, LiN₂H₅SO₄, NH₄HSO₄,

phosphates, in particular Zr₃(PO₄)₄, Zr(HPO₄)₂, HZr₂(PO₄)₃, UO₂PO₄.3H₂O, H₈UO₂PO₄, Ce(HPO₄)₂, Ti(HPO₄)₂, KH₂PO₄, NaH₂PO₄, LiH₂PO₄, NH₄H₂PO₄, CsH₂PO₄, CaHPO₄, MgHPO₄, HSbP₂O₈, HSb₃P₂O₁₄, H₅Sb₅P₂O₂₀,
polyacids, in particular H₃PW₁₂O₄₀.nH₂O (n=21-29), H₃SiW₁₂O₄₀.nH₂O (n=21-29), HₓWO₃, HSbWO₆, H₃PMo₁₂O₄₀, H₂Sb₄O₁₁, HTaWO₆, HNbO₃, HTiNbO₅, HTiTaO₅, HSbTeO₆, H₅Ti₄O₉, HSbO₃, H₂MoO₄,
selenites and arsenites, in particular (NH₄)₃H(SeO₄)₂, UO₂AsO₄, (NH₄)₃H(SeO₄)₂, KH₂AsO₄, Cs₃H(SeO₄)₂, Rb₃H(SeO₄)₂,
phosphides, in particular ZrP, TiP, HfP,
oxides, in particular Al₂O₃, Sb₂O₅, ThO₂, SnO₂, ZrO₂, MoO₃,
silicates, in particular zeolites, zeolites(NH₄+), phyllosilicates, tectosilicates, H-natrolites, H-mordenites, NH₄-analcines, NH₄-sodalites, NH₄-gallates, H-montmorillonites,
acids, in particular HClO₄, SbF₅,
fillers, preferably carbides, in particular SiC, Si₃N₄,
fibres, in particular glass fibres, glass powders and/or polymer fibres, preferably based on polyazoles.

These additives can be included in the proton-conducting polymer membrane in usual amounts, however, the positive properties of the membrane, such as great conductivity, long service life and high mechanical stability should not be affected too much by the addition of too large amounts of additives. Generally, the membrane comprises not more than 80% by weight, preferably not more than 50% by weight and particularly preferably not more than 20% by weight, of additives.

As a further component, this membrane can also contain perfluorinated sulphonic acid additives (in particular 0.1-20% by weight, preferably 0.2-15% by weight, very preferably 0.2-10% by weight). These additives result in an improvement in performance, to an increase in oxygen solubility and oxygen diffusion in the vicinity of the cathode and to a reduction in adsorption of the electrolyte on the catalyst surface. (Electrolyte additives for phosphoric acid fuel cells. Gang, Xiao; Hjuler, H. A.; Olsen, C.; Berg, R. W.; Bjerrum, N.J. Chem. Dep. A, Tech. Univ. Denmark, Lyngby, Den, J. Electrochem. Soc. (1993), 140(4), 896-902, and Perfluorosulfonimide as an additive in phosphoric acid fuel cell. Razaq, M.; Razaq, A.; Yeager, E.; DesMarteau, Darryl D.; Singh, S. Case Cent, Electrochem. Sci., Case West. Reserve Univ., Cleveland, Ohio, USA. J. Electrochem. Soc. (1989), 136(2), 385-90.)

Non-limiting examples of perfluorinated sulphonic acid additives are: trifluoromethanesulphonic acid, potassium trifluoromethanesulphonate, sodium trifluoromethanesulphonate, lithium trifluoromethanesulphonate, ammonium trifluoromethanesulphonate, potassium perfluorohexanesulphonate, sodium perfluorohexanesulphonate, lithium perfluorohexanesulphonate, ammonium perfluorohexanesulphonate, perfluorohexanesulphonic acid, potassium nonafluorobutanesulphonate, sodium nonafluorobutanesulphonate, lithium nonafluorobutanesulphonate, ammonium nonafluorobutanesulphonate, caesium nonafluorobutanesulphonate, triethylammonium perfluorohexanesulphonate and perfluorosulphoimides.

The production of the membrane can be performed in a manner known per se, for example by mixing the components and subsequently forming a flat structure, in particular by pouring, spraying, application with a doctor blade or extrusion, on a support. Every support that is considered as inert under the conditions is suitable as a support. These supports include in particular films made of polyethylene terephthalate (PET), polytetrafluoroethylene (PTFE), polyhexafluoropropylene, copolymers of PTFE with hexafluoropropylene, polyimides, polyphenylenesulphides (PPS) and polypropylene (PP).

According to a preferred variant, the membrane components are dissolved in at least one polar, aprotic solvent, such as for example dimethylacetamide (DMAc) and a film is produced by means of conventional methods.

In order to remove residues of solvents, the film thus obtained can be treated with a washing liquid as in German patent application DE 101 098 29. Due to the cleaning of the film to remove residues of solvent described in the German patent application, the mechanical properties of the film are surprisingly improved. These properties include in particular the modulus of elasticity, the tear strength and the break strength of the film.

Additionally, the polymer film can have further modifications, for example by cross-linking, as described in German patent application DE 101 107 52 or in WO 00/44816. In a preferred embodiment, the polymer film used consisting of an alkaline polymer and at least one blend component additionally contains a cross-linking agent, as described in German patent application DE 101 401 47.

In order to achieve proton conductivity, the membrane is doped with at least one acid. In this context, acids include all known Lewis und Brønsted acids, preferably inorganic Lewis und Brønsted acids.

Furthermore, the application of polyacids is also possible, in particular isopolyacids and heteropolyacids, as well as mixtures of different acids. Here, in the spirit of the invention, heteropolyacids define inorganic polyacids with at least two different central atoms, each formed of weak, polybasic oxygen acids of a metal (preferably Cr, MO, V, W) and a non-metal (preferably As, I, P, Se, Si, Te) as partial mixed anhydrides. These include, amongst others, the 12-phosphomolybdatic acid and the 12-phosphotungstic acid.

The conductivity of the membrane can be influenced via the degree of doping. The conductivity increases with an increasing concentration of the doping substance until a maximum value is reached.

According to the invention, the degree of doping is given as mole of acid per mole of repeating unit of the polymer. Within the scope of the present invention, a degree of doping between 3 and 80, conveniently between 5 and 60, in particular between 12 and 60 is preferred.

Particularly preferred doping substances are sulphuric acid and phosphoric acid as well as compounds releasing these acids for example during hydrolysis. A very particularly preferred doping substance is phosphoric acid (H₃PO₄). Here, highly concentrated acids are generally used. According to a particular aspect of the present invention, the concentration of the phosphoric acid is at least 50% by weight, in particular at least 80% by weight, based on the weight of the doping substance.

Furthermore, proton-conductive membranes can also be obtained by a method comprising the steps of
I) dissolving the polymer according to the invention and the polymer (B) in at least one acid, preferably phosphoric acid or polyphosphoric acid, in particular polyphosphoric acid,
II) heating the solution obtainable in accordance with step I) under inert gas to temperatures of up to 400° C.,
III) forming a membrane using the solution of the polymer in accordance with step II) on a support and
IV) treatment of the membrane formed in step III) until it is self-supporting.

Further information about this variant of the method can be found, for example, in DE 102 464 61, the disclosure of which is incorporated by reference herein.

Furthermore, doped membranes can be obtained by a method comprising the steps of
A) mixing the polymer according to the invention with one or more aromatic tetramino compounds and one or more aromatic carboxylic acids or esters thereof which contain at least two acid groups per carboxylic acid monomer, or mixing the polymer according to the invention with one or more aromatic and/or heteroaromatic diaminocarboxylic acids in at least one acid, preferably phosphoric acid or polyphosphoric acid, in particular polyphosphoric acid, with formation of a solution and/or dispersion,
B) applying a layer using the mixture in accordance with step A) to a support or to an electrode,
C) heating the flat structure/layer obtainable in accordance with step B) under inert gas to temperatures of up to 350° C., preferably up to 280° C., with formation of the polyazole polymer,
D) treatment of the membrane formed in step C) (until it is self-supporting).

Further details of this variant of the method can be found, for example, in DE 102 464 59, the disclosure of which is incorporated by reference herein.

The aromatic or heteroaromatic carboxylic acid and tetramino compounds to be employed in step A) have been described above.

The polyphosphoric acid used in step A) is preferably a customary polyphosphoric acid as is available, for example, from Riedel-de Haen. The polyphosphoric acids Hₙ₊₂PₙO₃ₙ₊₁ (n>1) usually have a concentration of at least 83%, calculated as P₂O₅ (by acidimetry). Instead of a solution of the monomers, it is also possible to produce a dispersion/suspension.

The mixture produced in step A) has a weight ratio of acid to the sum of the polymers and the monomers of 1:10,000 to 10,000:1, preferably 1:1000 to 1000:1, in particular 1:100 to 100:1.

The layer formation in accordance with step B) is preferably performed by means of measures known per se (pouring, spraying, application with a doctor blade) which are known from the prior art of polymer film production. Every support that is considered as inert under the conditions is suitable as a support. To adjust the viscosity, phosphoric acid (conc. phosphoric acid, 85%) can be added to the solution, where required. Thus, the viscosity can be adjusted to the desired value and the formation of the membrane be facilitated.

The layer produced in accordance with step B) has a thickness of 20 to 4000 μm, preferably of 30 to 3500 μm, in particular of 50 to 3000 μm.

If the mixture in accordance with step A) also contains tricarboxylic acids or tetracarboxylic acid, branching/cross-linking of the formed polymer is achieved therewith. This contributes to an improvement in the mechanical property.

The treatment of the polymer layer produced in accordance with step C) in the presence of moisture at temperatures and for a period of time until the layer exhibits a sufficient strength for use in fuel cells. The treatment can be effected to the extent that the membrane is self-supporting so that it can be detached from the support without any damage.

In accordance with step C), the flat structure obtained in step B) is heated to a temperature of up to 350° C., preferably up to 280° C. and particularly preferably in the range of 200° C. to 250° C. The inert gases to be employed in step C) are known to those in professional circles. These include in particular nitrogen as well as noble gases, such as neon, argon, helium.

In a variant of the method, the formation of oligomers and polymers can already be brought about by heating the mixture resulting from step A) to temperatures of up to 350° C., preferably up to 280° C. Depending on the selected temperature and duration, it is than possible to dispense partly or fully with the heating in step C). This variant is also an object of the present invention.

The treatment of the membrane in step D) is performed at temperatures above 0° C. and below 150° C., preferably at temperatures between 10° C. and 120° C., in particular between room temperature (20° C.) and 90° C., in the presence of moisture or water and/or steam and/or water-containing phosphoric acid of up to 85%. The treatment is preferably performed at normal pressure, but can also be carried out with action of pressure. It is essential that the treatment takes place in the presence of sufficient moisture whereby the possibly present polyphosphoric acid contributes to the solidification of the membrane by means of partial hydrolysis with formation of low-molecular polyphosphoric acid and/or phosphoric acid.

The partial hydrolysis of the polyphosphoric acid in step D) leads to a solidification of the membrane and a reduction in the layer thickness and the formation of a membrane having a thickness between 15 and 3000 μm, preferably between 20 and 2000 μm, in particular between 20 and 1500 μm, which is self-supporting.

The intramolecular and intermolecular structures (interpenetrating networks IPN) present in the polyphosphoric acid layer in accordance with step B) lead to an ordered membrane formation in step C), which is responsible for the particular properties of the membrane formed.

The upper temperature limit for the treatment in accordance with step D) is typically 150° C. With extremely short action of moisture, for example from overheated steam, this steam can also be hotter than 150° C. The duration of the treatment is substantial for the upper limit of the temperature.

The partial hydrolysis (step D) can also take place in climatic chambers where the hydrolysis can be specifically controlled with defined moisture action. In this connection, the moisture can be specifically set via the temperature or saturation of the surrounding area in contact with it, for example gases, such as air, nitrogen, carbon dioxide or other suitable gases, or steam. The duration of the treatment depends on the parameters chosen as aforesaid.

Furthermore, the duration of the treatment depends on the thickness of the membrane.

Typically, the duration of the treatment amounts to between a few seconds to minutes, for example with the action of overheated steam, or up to whole days, for example in the open air at room temperature and lower relative humidity. Preferably, the duration of the treatment is between 10 seconds and 300 hours, in particular 1 minute to 200 hours.

If the partial hydrolysis is performed at room temperature (20° C.) with ambient air having a relative humidity of 40-80%, the duration of the treatment is between 1 and 200 hours.

The membrane obtained in accordance with step D) can be formed in such a way that it is self-supporting, i.e. it can be detached from the support without any damage and then directly processed further, if applicable.

The concentration of phosphoric acid and therefore the conductivity of the polymer membrane can be set via the degree of hydrolysis, i.e. the duration, temperature and ambient humidity. The concentration of the phosphoric acid is given as mole of acid per mole of repeating unit of the polymer. Therefore, especially membranes with a particularly high concentration of phosphoric acid can be obtained by the method comprising the steps A) to D). A concentration (mol of phosphoric acid, based on a repeating unit of formula (I), for example polybenzimidazole) of 10 to 50, in particular between 12 and 40 is preferred.

According to a modification of the method described above wherein doped membranes are produced by using at least one acid, preferably phosphoric acid or polyphosphoric acid, in particular polyphosphoric acid, the production of these films can also be carried out by a method comprising the steps of
1) reacting one or more aromatic tetramino compounds with one or more aromatic carboxylic acids or esters thereof which contain at least two acid groups per carboxylic acid monomer, or one or more aromatic and/or heteroaromatic diaminocarboxylic acids in the melt at temperatures of up to 350° C., preferably up to 300° C.,
2) dissolving the solid prepolymer obtained in accordance with step 1) and the polymer according to the invention in at least one acid, preferably phosphoric acid or polyphosphoric acid, in particular polyphosphoric acid,
3) heating the solution obtainable in accordance with step 2) under inert gas to temperatures of up to 300° C., preferably up to 280° C., with formation of the dissolved polyazole polymer,
4) forming a membrane using the solution in accordance with step 3) on a support and
5) treatment of the membrane formed in step 4) until it is self-supporting.

The steps of the method described under items 1) to 5) have been explained before in detail for the steps A) to D), where reference is made thereto, in particular with regard to preferred embodiments.

Further details of this variant of the method can be found, for example, in DE 102 464 59, the disclosure of which is incorporated by reference herein.

The membrane according to the invention is characterized by an excellent property profile. The water content of the proton-conducting membrane is preferably not more than 15% by weight, particularly preferably not more than 10% by weight and very particularly preferably not more than 5% by weight.

In this connection, it can be assumed that the conductivity of the membrane may be based on the Grotthus mechanism whereby the system does not require any additional humidification. According to a particularly preferred embodiment of the invention, preferred membranes therefore comprise proportions of polymers comprising low-molecular phosphonic acid groups. Thus, the proportion of polymers comprising phosphonic acid groups with a degree of polymerisation in the range of 2 to 20 can preferably be at least 10% by weight, particularly preferably at least 20% by weight, based on the weight of the polymers comprising phosphonic acid groups.

The layer thickness of the membrane is conveniently between 5 and 2000 μm, preferably between 15 and 1000 μm, preferably between 20 and 500 μm, in particular between 30 and 250 μm.

Furthermore, the membrane is preferably self-supporting, i.e. it can be detached from a support without any damage and then directly processed further, if applicable.

According to a particular embodiment of the present invention, the membrane exhibits a high mechanical stability. This variable results from the hardness of the membrane which is determined via microhardness measurement in accordance with DIN 50539. To this end, the membrane is successively loaded over 20 s with a Vickers diamond up to a force of 3mN and the depth of indentation is determined. According to this, the hardness at room temperature is at least 0.01 N/mm², preferably at least 0.1 N/mm² and very particularly preferably at least 1 N/mm²; however, this should not constitute a limitation. Subsequently, the force is kept constant at 3 mN over 5 s and the creep of the depth of penetration is calculated. In preferred membranes, the creep C_{HU} 0.003/20/5 is less than 20% under these conditions, preferably less than 10% and very particularly preferably less than 5%. The modulus determined by microhardness measurement, YHU is at least 0.5 MPa, in particular at least 5 MPa and very particularly preferably at least 10 MPa; however, this should not constitute a limitation.

The hardness of the membrane relates to both a surface which does not have a catalyst layer and a face that has a catalyst layer.

The membrane can be cross-linked thermally, photochemically, chemically and/or electrochemically to improve the properties of the membrane further.

According to a particular aspect, the membrane can be heated to a temperature of at least 150° C., preferably at least 200° C. and particularly preferably at least 250° C. Preferably, the thermal cross-linking takes place in the presence of oxygen. In this step of the method, the oxygen concentration usually is in the range of 5 to 50% by volume, preferably 10 to 40% by volume; however, this should not constitute a limitation.

The cross-linking can also take place by action of IR or NIR (IR infrared, i.e. light having a wavelength of more than 700 nm; NIR=near-IR, i.e. light having a wavelength in the range of about 700 to 2000 nm and an energy in the range of about 0.6 to 1.75 eV), respectively, and/or UV light. Another method is exposure to βrays, γ rays and/or electron rays. In this connection, the radiation dose is preferably between 5 and 250 kGy, in particular 10 to 200 kGy. The irradiation can take place in the open air or under inert gas. Through this, the usage properties of the membrane, in particular its durability, are improved.

Depending on the degree of cross-linking desired, the duration of the cross-linking reaction can be within a wide range. Generally, this reaction time is in the range of 1 second to 10 hours, preferably 1 minute to 1 hour; however, this should not constitute a limitation.

According to a particular embodiment of the present invention, the membrane comprises, according to an elemental analysis, at least 3% by weight, preferably at least 5% by weight and particularly preferably at least 7% by weight, of sulphur and/or phosphorus, in particular phosphorus, based on the total weight of the membrane. The proportion of sulphur and/or phosphorus can be determined by elemental analysis. To this end, the membrane is dried at 110° C. for 3 hours under vacuum (1 mbar).

The membrane preferably has a content of sulphonic acid groups and/or phosphonic acid groups, in particular of phosphonic acid groups, of at least 5 meq/g, particularly preferably at least 10 meq/g. This value is determined by way of the so-called ion exchange capacity (IEC).

To measure the IEC, the acid groups are converted into the free acid and subsequently titrated with 0.1M NaOH. The ion exchange capacity (IEC) is then calculated from the consumption of acid up to the equivalent point and the dry weight.

The polymer membrane according to the invention has improved material properties compared to the doped polymer membranes previously known. In particular, they exhibit better performances than known doped polymer membranes. The reason for this is in particular an improved proton conductivity. This is at least 1 mS/cm, preferably at least 2 mS/cm, in particular at least 5 mS/cm at temperatures of 120° C.

Furthermore, the membranes also exhibit a high conductivity at a temperature of 70° C. The conductivity is dependent inter alia on the content of sulphonic acid groups in the membrane. The higher this proportion, the better is the conductivity at low temperatures. In this connection, a membrane according to the invention can be humidified at low temperatures. To this end, the compound used as energy source, for example hydrogen, may be provided with a proportion of water. In many cases, however, the water formed by the reaction is sufficient to achieve wetting.

The specific conductivity is measured by means of impedance spectroscopy in a 4-pole arrangement in potentiostatic mode and using platinum electrodes (wire, diameter of 0.25 mm). The gap between the current-collecting electrodes is 2 cm. The spectrum obtained is evaluated using a simple model consisting of a parallel arrangement of an ohmic resistance and a capacitor. The cross section of the sample of the membrane doped with phosphoric acid is measured immediately prior to mounting of the sample. To measure the temperature dependency, the measurement cell is brought to the desired temperature in an oven and regulated using a Pt-100 thermocouple arranged in the immediate vicinity of the sample. Once the temperature is reached, the sample is held at this temperature for 10 minutes prior to the start of measurement.

In addition to the polymer electrolyte membrane, the membrane electrode assembly according to the invention further comprises at least two electrochemically active electrodes (anode and cathode) which are separated by the polymer electrolyte membrane. The term “electrochemically active” indicates that the electrodes are capable to catalyse the oxidation of hydrogen and/or at least one reformate and the reduction of oxygen. This property can be obtained by coating the electrodes with platinum and/or ruthenium. The term “electrode” means that the material is electrically conductive. The electrode can optionally include a precious-metal layer. Such electrodes are known and are described in U.S. Pat. No. 4,191,618, U.S. Pat. No. 4,212,714 and U.S. Pat. No. 4,333,805, for example.

The electrodes preferably comprise gas diffusion layers, which are in contact with a catalyst layer.

Flat, electrically conductive and acid-resistant structures are commonly used as gas diffusion layers. These include, for example, graphite-fibre paper, carbon-fibre paper, graphite fabric and/or paper which was rendered conductive by addition of carbon black. Through these layers, a fine distribution of the flows of gas and/or liquid is achieved.

Furthermore, it is also possible to use gas diffusion layers which contain a mechanically stable stabilizing material which is impregnated with at least one electrically conductive material, e.g., carbon (for example carbon black). Particularly suitable stabilizing materials for these purposes comprise fibres, for example in the form of non-woven fabrics, paper or fabrics, in particular carbon fibres, glass fibres or fibres containing organic polymers, for example polypropylene, polyester (polyethylene terephthalate), polyphenylenesulphide or polyether ketones. Further details of such diffusion layers can be found in WO 9720358, for example.

The gas diffusion layers preferably have a thickness in the range of 80 μm to 2000 μm, in particular in the range of 100 μm to 1000 μm and particularly preferably in the range of 150 μm to 500 μm.

Furthermore, the gas diffusion layers conveniently have a high porosity. This is preferably in the range of 20% to 80%.

The gas diffusion layers can contain customary additives. These include, amongst others, fluoropolymers, such as, e.g., polytetrafluoroethylene (PTFE) and surface-active substances.

According to a particular embodiment, at least one of the gas diffusion layers can consist of a compressible material. Within the context of the present invention, a compressible material is characterized by the property that the gas diffusion layer can be compressed to half, in particular a third of its original thickness without losing its integrity.

This property is generally exhibited by gas diffusion layers made of graphite fabric and/or paper which was rendered conductive by addition of carbon black. The catalyst layer or catalyst layers contain catalytically active substances. These include, amongst others, precious metals of the platinum group, i.e. Pt, Pd, Ir, Rh, Os, Ru, or also the precious metals Au and Ag. Alloys of all the above-mentioned metals may also be used. Additionally, at least one catalyst layer can contain alloys of the elements of the platinum group with non-precious metals, such as for example Fe, Co, Ni, Cr, Mn, Zr, Ti, Ga, V, etc. Furthermore, the oxides of the above-mentioned precious metals and/or non-precious metals can also be employed.

The catalytically active particles comprising the above-mentioned substances may be used as metal powder, so-called black precious metal, in particular platinum and/or platinum alloys. Such particles generally have a size in the range of 5 nm to 200 nm, preferably in the range of 7 nm to 100 nm.

Furthermore, the metals can also be employed on a support material. Preferably, this support comprises carbon which may particularly be used in the form of carbon black, graphite or graphitised carbon black. Furthermore, electrically conductive metal oxides, such as for example, SnOₓ, TiOₓ, or phosphates, such as e.g. FePOₓ, NbPOₓ, Zr_{y}(POₓ)_{z}, can be used as support material. In this connection, the indices x, y and z designate the oxygen or metal content of the individual compounds which can lie within a known range as the transition metals can be in different oxidation stages.

The content of these metal particles on a support, based on the total weight of the bond of metal and support, is generally in the range of 1 to 80% by weight, preferably 5 to 60% by weight and particularly preferably 10 to 50% by weight; however, this should not constitute a limitation. The particle size of the support, in particular the size of the carbon particles, is preferably in the range of 20 to 1000 nm, in particular 30 to 100 nm. The size of the metal particles present thereon is preferably in the range of 1 to 20 nm, in particular 1 to 10 nm and particularly preferably 2 to 6 nm.

The sizes of the different particles represent mean values and can be determined via transmission electron microscopy or X-ray powder diffractometry.

The catalytically active particles set forth above can generally be obtained commercially.

Furthermore, the catalytically active layer may contain customary additives. These include, amongst others, fluoropolymers, such as, e.g., polytetrafluoroethylene (PTFE), proton-conducting ionomers and surface-active substances.

According to a particular embodiment of the present invention, the weight ratio of fluoropolymer to catalyst material comprising at least one precious metal and optionally one or more support materials is greater than 0.1, this ratio preferably lying within the range of 0.2 to 0.6.

Furthermore, the catalyst layer preferably has a thickness in the range of 1 to 1000 μm, in particular in the range of 5 to 500, preferably in the range of 10 to 300 μm. This value represents a mean value, which can be determined by averaging the measurements of the layer thickness from photographs that can be obtained with a scanning electron microscope (SEM).

According to a particular embodiment of the present invention, the content of precious metals of the catalyst layer is 0.1 to 10.0 mg/cm², preferably 0.3 to 6.0 mg/cm² and particularly preferably 0.3 to 3.0 mg/cm². These values can be determined by elemental analysis of a flat sample.

For further information on membrane electrode assemblies, reference is made to the technical literature, in particular the patent applications WO 01/18894 A2, DE 195 09 748, DE 195 09 749, WO 00/26982, WO 92/15121 and DE 197 57 492. The disclosure contained in the above-mentioned references with respect to the structure and production of membrane electrode assemblies as well as the electrodes, gas diffusion layers and catalysts to be chosen is also part of the description.

The electrochemically active surface of the catalyst layer defines the surface which is in contact with the polymer electrolyte membrane and at which the redox reactions set forth above can take place. The present invention allows for the formation of particularly large electrochemically active surface areas. According to a particular aspect of the present invention, the size of this electrochemically active surface is at least 2 cm², in particular at least 5 cm² and preferably at least 10 cm²; however, this should not constitute a limitation. The term electrode means that the material exhibits electron conductivity, the electrode defining the electrochemically active area.

The polymer electrolyte membrane has an inner area which is in contact with a catalyst layer, and an outer area which is not provided on the surface of a gas diffusion layer. In this connection, provided means that the inner area has no area overlapping with a gas diffusion layer if an inspection perpendicular to the surface of a gas diffusion layer or of the outer area of the polymer electrolyte membrane is carried out, such that, only after contacting the polymer electrolyte membrane with the gas diffusion layer, an allocation can be made.

The outer area of the polymer electrolyte membrane can have a monolayer structure. In this case, the outer area of the polymer electrolyte membrane generally consists of the same material as the inner area of the polymer electrolyte membrane.

Furthermore, the outer area of the polymer electrolyte membrane can comprise in particular at least one more layer, preferably at least two more layers. In this case, the outer area of the polymer electrolyte membrane has at least two or at least three components.

The thickness of all components of the outer area of the polymer electrolyte membrane is greater than the thickness of the inner area of the polymer electrolyte membrane. The thickness of the outer area relates to the sum of the thicknesses of all components of the outer area. The components of the outer area result from the vector parallel to the surface area of the outer area of the polymer electrolyte membrane, wherein the layers that this vector intersects are to be added to the components of the outer area.

The outer area preferably has a thickness in the range of 80 μm to 4000 μm, in particular in the range of 120 μm to 2000 μm and particularly preferably in the range of 150 μm to 800 μm.

The thickness of all components of the outer area is 50% to 100%, preferably 65% to 95% and particularly preferably 75% to 85%, based on the sum of the thicknesses of all components of the inner area. In this connection, the thickness of the components of the outer area relates to the thickness these components have after a first compression step which is performed at a pressure of 5 N/mm², preferably 10 N/mm² over a period of 1 minute. The thickness of the components of the inner area relates to the thicknesses of the layers employed, without a compression step being necessary in this connection.

The thickness of all components of the inner area results in general from the sum of the thicknesses of the membrane, the catalyst layers and the gas diffusion layers of the anode and cathode.

The thickness of the layers is determined with a digital thickness tester from the company Mitutoyo. The contact pressure of the two circular flat contact surfaces during measurement is 1 PSI, the diameter of the contact surface is 1 cm.

The catalyst layer is in general not self-supporting but is usually applied to the gas diffusion layer and/or the membrane. In this connection, part of the catalyst layer can, for example, diffuse into the gas diffusion layer and/or the membrane, resulting in the formation of transition layers. This can also lead to the catalyst layer being understood as part of the gas diffusion layer. The thickness of the catalyst layer results from measuring the thickness of the layer onto which the catalyst layer was applied, for example the gas diffusion layer or the membrane, the measurement providing the sum of the catalyst layer and the corresponding layer, for example the sum of the gas diffusion layer and the catalyst layer.

The thickness of the components of the outer area decreases over a period of 5 hours by not more than 5% at a temperature of 80° C. and a pressure of 5 N/mm², wherein this decrease in thickness is determined after a first compression step which takes place over a period of 1 minute at a pressure of 5 N/mm², preferably 10 N/mm².

The measurement of the pressure- and temperature-dependent deformation parallel to the surface vector of the components of the outer area, in particular the outer area of the polymer electrolyte membrane, is performed with a hydraulic press with heatable press plates.

In this connection, the hydraulic press exhibits the following technical data:

The press has a force range of 50-50000 N with a maximum compression area of 220×220 mm². The resolution of the pressure sensor is ±1 N.

An inductive distance sensor with a measuring range of 10 mm is attached to the press plates. The resolution of the distance sensor is ±1 μm.

The press plates can be operated in a temperature range of RT −200° C.

The press is operated in a force-controlled mode by means of a PC with corresponding software.

The data of the force sensor and the distance sensor is recorded and depicted in real time at a data rate of up to 100 measured data/second.

### Testing Method:

The material to be tested is cut to a surface area of 55×55 mm² and placed between the press plates preheated to 80° C., 120° C. and 160° C., respectively.

The press plates are closed and an initial force of 120 N is applied such that the control circuit of the press is closed. At this point, the distance sensor is set to 0. Subsequently, a pressure ramp previously programmed is executed. To this end, the pressure is increased at a rate of 2 N/mm²s to a predefined value, for example 5, 10, 15 or 20 N/mm² and this value is maintained for at least 5 hours. After completing the total holding time, the pressure is decreased to 0 N/mm² with a ramp of 2 N/mm²s and the press is opened.

The relative and/or absolute change in thickness can be read from a deformation curve recorded during the pressure test or can be measured following the pressure test through a measurement with a standard thickness tester.

This characteristic of the components of the outer area is generally achieved through the use of polymers having a high pressure stability. In this connection, the polymer electrolyte membrane can have a particularly high degree of cross-linking in the outer area which can be achieved by specific irradiation as has been described above.

Preferably, the outer area of the membrane is irradiated with a dose of at least 100 kGy, preferably at least 132 kGy and particularly preferably at least 200 kGy. The inner area of the membrane is preferably irradiated with a dose of not more than 130 kGy, preferably not more than 99 kGy and particularly preferably not more than 80 kGy. The ratio of irradiation power of the outer area to irradiation power of the inner area is preferably at least 1.5, particularly preferably at least 2 and very particularly preferably at least 2.5.

The irradiation of the outer area can furthermore preferably be performed with a UV lamp having a power of at least 50 W, in particular 100 W and particularly preferably 200 W. In this connection, the duration can be within a wide range. Preferably, the irradiation is carried out for at least one minute, in particular at least 30 minutes and particularly preferably at least 5 hours, in many cases an irradiation of up to 30 hours, in particular up to 10 hours being sufficient. The ratio of duration of irradiation of the outer area to duration of irradiation of the inner area is preferably at least 1.5, particularly preferably at least 2 and very particularly preferably at least 2.5.

If the outer area has a multilayer structure, these materials generally likewise exhibit high pressure stability.

Preferably, the thickness of the components of the outer area decreases over a period of 5 hours, particularly preferably 10 hours, by not more than 5%, in particular not more than 2%, preferably not more than 1%, at a temperature of 120° C., particularly preferably 160° C., and a pressure of 5 N/mm², preferably 10 N/mm², in particular 15 N/mm² and particularly preferably 20 N/mm².

According to a particular aspect of the present invention, the outer area comprises at least one, preferably at least two polymer layers having a thickness greater than or equal to 10 μm, each of the polymers of these layers having a modulus of elasticity of at least 6 N/mm², preferably at least 7 N/mm², measured at 80° C., preferably 160° C., and an elongation of 100%. Measurement of these values is carried out in accordance with DIN EN ISO 527-1.

According to a particular aspect of the present invention, a layer can be applied by thermoplastic methods, for example injection moulding or extrusion. Accordingly, a layer is preferably made of a meltable polymer.

Within the context of the present invention, preferably used polymers preferably exhibit a long-term service temperature of at least 190° C., preferably at least 220° C. and particularly preferably at least 250° C., measured in accordance with MIL-P-46112B, paragraph 4.4.5.

Preferred meltable polymers include in particular fluoropolymers, such as for example poly(tetrafluoroethylene-co-hexafluoropropylene) FEP, polyvinylidenefluoride PVDF, perfluoroalkoxy polymer PFA, poly(tetrafluoroethylen-co-perfluoro(methylvinylether)) MFA. These polymers are in many cases commercially available, for example under the trade names Hostafon®, Hyflon®, Teflon®, Dyneon® and Nowoflon®.

One or both layers can be made of, amongst others, polyphenylenes, phenol resins, phenoxy resins, polysulphide ether, polyphenylenesulphide, polyethersulphones, polyimines, polyetherimines, polyazoles, polybenzimidazoles, polybenzoxazoles, polybenzothiazoles, polybenzoxadiazoles, polybenzotriazoles, polyphosphazenes, polyether ketones, polyketones, polyether ether ketones, polyether ketone ketones, polyphenylene amides, polyphenylene oxides, polyimides and mixtures of two or more of these polymers.

The polyimides also include polymers also containing, besides imide groups, amide (polyamideimides), ester (polyesterimides) and ether groups (polyetherimides) as components of the backbone.

The different layers can be connected with each other by use of suitable polymers. These include in particular fluoropolymers. Suitable fluoropolymers are known to those in professional circles. These include, amongst others, polytetrafluoroethylene (PTFE) and poly(tetrafluoroethylen-co-hexafluoropropylene) (FEP). In general, the layer made of fluoropolymers present on the layers described above has a thickness of at least 0.5 μm, in particular at least 2.5 μm. This layer can be provided between the polymer electrolyte membrane and further layers. Furthermore, the layer can also be applied to the side facing away from the polymer electrolyte membrane. Additionally, both surfaces of the layers to be laminated can be provided with a layer made of fluoropolymers. Surprisingly, it is possible to improve the long-term stability of the MEAs through this.

At least one component of the outer area of the polymer electrolyte membrane is usually in contact with electrically conductive separator plates which are typically provided with flow field channels on the sides facing the gas diffusion layers to allow for the distribution of reactant fluids. The separator plates are usually manufactured of graphite or conductive, thermally stable plastic.

Interacting with the separator plates, the components of the outer area seal the gas spaces against the outside. Furthermore, interacting with the inner area of the polymer electrolyte membrane, the components of the outer area generally also seal the gas spaces between anode and cathode. Surprisingly, it was therefore found that an improved sealing concept can result in a fuel cell with a prolonged service life.

The production of the membrane electrode assembly according to the invention is apparent to the person skilled in the art. Generally, the different components of the membrane electrode assembly are superposed and connected with each other by pressure and temperature. In general, lamination is carried out at a temperature in the range of 10 to 300° C., in particular 20° C. to 200° C. and with a pressure in the range of 1 to 1000 bar, in particular 3 to 300 bar.

The outer area of the polymer electrolyte membrane can subsequently be thickened by a second polymer layer. This second layer can be laminated on, for example. Furthermore, the second layer can also be applied by thermoplastic methods, for example extrusion or injection moulding.

After cooling, the finished membrane electrode assembly (MEA) is operational and can be used in a fuel cell.

Particularly surprising, it was found that due to their dimensional stability at varying ambient temperatures and humidity, individual fuel cells according to the invention can be stored or shipped without any problems. Even after prolonged storage or after shipping to locations with markedly different climatic conditions, the dimensions of the individual fuel cells are right to be fitted into fuel cell stacks without difficulty. In this case, the individual fuel cell need not be conditioned for an external assembly on site which simplifies the production of the fuel cell and saves time and cost.

One benefit of preferred individual fuel cells is that they allow for the operation of the fuel cell at temperatures above 120° C. This applies to gaseous and liquid fuels, such as, e.g., hydrogen-containing gases that are produced from hydrocarbons in an upstream reforming step, for example. In this connection, e.g. oxygen or air can be used as oxidant.

Another benefit of preferred individual fuel cells is that, during operation at more than 120° C., they have a high tolerance to carbon monoxide, even with pure platinum catalysts, i.e. without any further alloy components. At temperatures of 160° C., e.g., more than 1% of CO can be contained in the fuel gas without this leading to a remarkable reduction in performance of the fuel cell.

Preferred individual fuel cells can be operated in fuel cells without the need to humidify the fuel gases and the oxidants despite the high operating temperatures possible. The fuel cell nevertheless operates in a stable manner and the membrane does not lose its conductivity. This simplifies the entire fuel cell system and results in additional cost savings as the guidance of the water circulation is simplified. Furthermore, the behaviour of the fuel cell system at temperatures of less than 0° C. is also improved through this.

Preferred individual fuel cells surprisingly make it possible to cool the fuel cell to room temperature and lower without difficulty and subsequently put it back into operation without a loss in performance. In contrast, conventional fuel cells based on phosphoric acid sometimes also have to be held at a temperature above 40° C. when the fuel cell system is switched off in order to avoid irreversible damages.

Furthermore, the preferred individual fuel cells of the present invention exhibit a very high long-term stability. It was found that a fuel cell according to the invention can be continuously operated over long periods of time, e.g. more than 5000 hours, at temperatures of more than 120° C. with dry reaction gases without it being possible to detect an appreciable degradation in performance. The power densities obtainable in this connection are very high, even after such a long period of time.

In this connection, the fuel cells according to the invention exhibit, even after a long period of time, for example more than 5000 hours, a high open circuit voltage which after this period of time is preferably at least 900 mV. To measure the open circuit voltage, a fuel cell with a hydrogen flow on the anode and an air flow on the cathode is operated currentless. The measurement is carried out by switching the fuel cell from a current of 0.2 A/cm² to the currentless state and then recording the open circuit voltage for 5 minutes from this point onwards. The value after 5 minutes is the respective open circuit potential. The measured values of the open circuit voltage apply to a temperature of 160° C. Furthermore, the fuel cell preferably exhibits a low gas cross over after this period of time. To measure the cross over, the anode side of the fuel cell is operated with hydrogen (5 l/h), the cathode with nitrogen (5 l/h). The anode serves as the reference and counter electrode, the cathode as the working electrode. The cathode is set to a potential of 0.5 V and the hydrogen diffusing through the membrane and whose mass transfer is limited at the cathode oxidizes. The resulting current is a variable of the hydrogen permeation rate. The current is <3 mA/cm², preferably <2 mA/cm², particularly preferably <1 mA/cm² in a cell of 50 cm². The measured values of the H₂ cross over apply to a temperature of 160° C.

Furthermore, the individual fuel cells according to the invention are characterized by an improved temperature and corrosion resistance and a relatively low gas permeability, in particular at high temperatures. According to the invention, a decline of the mechanical stability and the structural integrity, in particular at high temperatures, is avoided as good as possible.

Furthermore, the individual fuel cells according to the invention can be produced inexpensive and in an easy way.

For further information on membrane electrode assemblies, reference is made to the technical literature, in particular the U.S. Pat. No. 4,191,618, U.S. Pat. No. 4,212,714 and U.S. Pat. No. 4,333,805. The disclosure contained in the above-mentioned citations [U.S. Pat. No. 4,191,618, U.S. Pat. No. 4,212,714 and U.S. Pat. No. 4,333,805] with respect to the structure and production of membrane electrode assemblies as well as the electrodes, gas diffusion layers and catalysts to be chosen is also part of the description.

In the following, the invention is further illustrated by examples and a comparative example without intending to restrict the teaching of the invention on these particular embodiments.

To characterize the polymers obtained, the following measurement methods were used.

### Static Light-Scattering

The determination of the molecular weight was executed by means of static light-scattering where the measurement was performed on a multi-angular laser light-scattering sensor (MALLS) DAWN DSP Laser Photometer (Wyatt Technology Co.). The device was equipped with an argon laser which emitted at a wavelength of 633 nm and scattered at an angle between 30-130°. The analysis was performed at 25° C. The specific refractive index increment was measured with an Optilab 903 interferometric refractometer at 25° C. and the refraction increment dn/dc was obtained by means of the Wyatt software. The measuring results were evaluated with the software ASTRA (Wyatt Corp.) using the Berry method based on the following formula:

√(Kc/R_{Θ})=(1/√(M_{w}))+2A₂c

K=4π²n₀²(dn/dc)²/N_{A}λ⁴

n₀: optical parameters
N_{A}: Avogadro constant
λ: wave length (633 nm)
M_{w}: weight average of the molecular weight of the apparatus
A₂: 2. Varial coefficient
R_{Θ}:Rayleigh ratio

The stock solution for the light-scattering measurements has a concentration of 1×10⁻³ g·mol¹. Each solution was cleaned before the measurement using a filter material with a pore size of 0.2 mm and later diluted with filtered stock solution.

### Inherent Viscosity

The samples were dissolved in water (0.4% by weight) and measured with an Ubelode viscometer at 25° C.

### COMPARATIVE EXAMPLE 1

Polyvinylphosphonic acid was purchased from Polyscience as a comparative sample. The properties of the polymer are summarized in Table 1.

### EXAMPLE 1

A mixture of 1 g of vinylphosphonic acid and 0.132 g of 2,2′-azobis-(2-amidinopropane) hydrochloride solution (V50 (Dupont); 20 wt-% aqueous solution) was exposed in a glass beaker to daylight for 3 days. A colourless solid formed which was washed with plenty of methanol and subsequently with ethyl acetate. The sample was thereafter dried under vacuum for 2 days (94% yield). The properties of the polymer obtained are summarized in Table 1.

### EXAMPLE 2

A mixture of 5 g of vinylphosphonic acid and 0.849 g of 2,2′-azobis-(2-amidinopropane) hydrochloride solution (V50 (Dupont); 20 wt-% aqueous solution) was exposed in a glass beaker to daylight for 5 days. A colourless solid formed which was washed with plenty of methanol and subsequently with ethyl acetate. The sample was thereafter dried under vacuum for 3 days (98% yield). The properties of the polymer obtained are summarized in Table 1.

### EXAMPLE 3

A flask was charged with 1.02 g of vinylphosphonic acid and 0.023 g of 2,2′-azobis-(2-amidinopropane) hydrochloride solution (V50 (Dupont)). The initiator did not dissolve in the vinylphosphonic acid. The mixture was treated three times, each time for 15 minutes, in an ultrasound bath at 30° C. Afterwards, the initiator was completely dissolved. The solution was exposed in a glass beaker to daylight for 7 days. A colourless solid formed which was washed with plenty of methanol and subsequently with ethyl acetate. The sample was thereafter dried under vacuum for 3 days (90% yield). The properties of the polymer obtained are summarized in Table 1.

TABLE 1
Properties

| | T | | M_{w} | Inherent viscosity |
|---|---|---|---|---|
| Sample | [° C.] | du/dc | [g/mol] | in water [dl/g] |
| Comparative | 25 | 0.154 | 31,850 | 0.18 |
| example 1 | | | | |
| Example 1 | 24 | 0.166 | 48,600 | 4.89 |
| Example 2 | 22 | 0.127 | 198,000 | 10.42 |
| Example 3 | 26 | 0.162 | 185,000 | 12.43 |

1-25. (canceled)

26. A method for producing a polymer with high molecular weight containing phosphonic acid groups comprising preparing a composition by free-radical polymerization which, based on its total weight, comprises at least 80.0% by weight of ethylenically unsaturated compounds, wherein said composition comprises at least one monomer comprising a phosphonic acid group.

27. The method of claim 26, wherein said monomer comprising a phosphonic acid group is of the formula 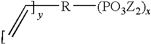
wherein
R is a bond, a divalent C₁-C₁₅ alkylene group, a divalent C₁-C₁₅ alkyleneoxy group, or a divalent C₅-C₂₀ aryl or heteroaryl group, optionally substituted with halogen, —OH, COOZ, —CN, and/or NZ₂;
Z is, independent of one another, H, a C₁-C₁₅ alkyl group, a C₁-C₁₅ alkoxy group, or a C₅-C₂₀ aryl or heteroaryl group, optionally substituted with halogen, —OH, and/or —CN;
x is an integer selected from the group consisting of 1, 2, 3, 4, 5, 6, 7, 8, 9, or 10; and
y is an integer selected from the group consisting of 1, 2, 3, 4, 5, 6, 7, 8, 9 or 10;
and/or of the formula 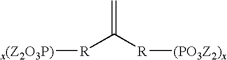
wherein
R is a bond, a divalent C₁-C₁₅ alkylene group, a divalent C₁-C₁₅ alkyleneoxy group, or a divalent C₅-C₂₀ aryl or heteroaryl group, optionally substituted with halogen, —OH, COOZ, —CN, and/or NZ₂;
Z is, independent of one another, H, a C₁-C₁₅ alkyl group, a C₁-C₁₅ alkoxy group, or a C₅-C₂₀ aryl or heteroaryl group, optionally substituted with halogen, —OH, and/or —CN; and
x is an integer selected from the group consisting of 1, 2, 3, 4, 5, 6, 7, 8, 9, or 10;
and/or of the formula 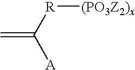
wherein
A is a group having the formulae COOR², CN, CONR²₂, OR², and/or R²;
R² is H, a C₁-C₁₅ alkyl group, a C₁-C₁₅ alkoxy group, or a C₅-C₂₀ aryl or heteroaryl group, optionally substituted with halogen, —OH, COOZ, —CN, and/or NZ₂;
R is a bond, a divalent C₁-C₁₅ alkylene group, a divalent C₁-C₁₅ alkyleneoxy group, or a divalent C₅-C₂₀ aryl or heteroaryl group, optionally substituted with halogen, —OH, COOZ, —CN, and/or NZ₂;
Z is, independent of one another, H, a C₁-C₁₅ alkyl group, a C₁-C₁₅ alkoxy group, or a C₅-C₂₀ aryl or heteroaryl group, optionally substituted with halogen, —OH, and/or —CN; and
x is an integer selected from the group consisting of 1, 2, 3, 4, 5, 6, 7, 8, 9, or 10.

28. The method of claim 27, wherein said monomer is selected from the group consisting of ethenephosphonic acid, propenephosphonic acid, butenephosphonic acid, 2-phosphonomethylacrylic acid, 2-phosphonomethylmethacrylic acid, 2-phosphonomethylacrylamide, 2-phosphonomethylmethacrylamide, and mixtures thereof.

29. The method of claim 26, wherein said composition, based on its total weight, comprises at least 20% by weight of at least one monomer comprising a phosphonic acid group.

30. A method for producing a polymer with high molecular weight containing sulphonic acid groups comprising preparing a composition by free-radical polymerization which, based on its total weight, comprises at least 80.0% by weight of ethylenically unsaturated compounds, wherein said composition comprises at least one monomer comprising a sulphonic acid group.

31. The method of claim 30, wherein said monomer comprising a sulphonic acid group is of the formula 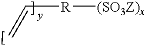
wherein
R is a bond, a divalent C₁-C₁₅ alkylene group, a divalent C₁-C₁₅ alkyleneoxy group, or a divalent C₅-C₂₀ aryl or heteroaryl group, optionally substituted with halogen, —OH, COOZ, —CN, and/or NZ₂;
Z is, independent of one another, H, a C₁-C₁₅ alkyl group, a C₁-C₁₅ alkoxy group, or a C₅-C₂₀ aryl or heteroaryl group, optionally substituted with halogen, —OH, and/or —CN;
x is an integer selected from the group consisting of 1, 2, 3, 4, 5, 6, 7, 8, 9, or 10; and
y is an integer selected from the group consisting of 1, 2, 3, 4, 5, 6, 7, 8, 9 or 10;
and/or of the formula 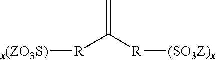
wherein
R is a bond, a divalent C₁-C₁₅ alkylene group, a divalent C₁-C₁₅ alkyleneoxy group, or a divalent C₅-C₂₀ aryl or heteroaryl group, optionally substituted with halogen, —OH, COOZ, —CN, and/or NZ₂;
Z is, independent of one another, H, a C₁-C₁₅ alkyl group, a C₁-C₁₅ alkoxy group, or a C₅-C₂₀ aryl or heteroaryl group, optionally substituted with halogen, —OH, and/or —CN; and
x is an integer selected from the group consisting of 1, 2, 3, 4, 5, 6, 7, 8, 9, or 10;
and/or of the formula 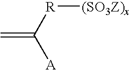
is sufficient,
wherein
A is a group having the formulae COOR², CN, CONR²₂, OR², and/or R²;
R² is H, a C₁-C₁₅ alkyl group, a C₁-C₁₅ alkoxy group, or a C₅-C₂₀ aryl or heteroaryl group, optionally substituted with halogen, —OH, COOZ, —CN, and/or NZ₂;
R is a bond, a divalent C₁-C₁₅ alkylene group, a divalent C₁-C₁₅ alkyleneoxy group, or a divalent C₅-C₂₀ aryl or heteroaryl group, optionally substituted with halogen, —OH, COOZ, —CN, and/or NZ₂;
Z is, independent of one another, H, a C₁-C₁₅ alkyl group, a C₁-C₁₅ alkoxy group, or a C₅-C₂₀ aryl or heteroaryl group, optionally substituted with halogen, —OH, and/or —CN; and
x is an integer selected from the group consisting of 1, 2, 3, 4, 5, 6, 7, 8, 9, or 10.

32. The method of claim 31, wherein said monomer is selected from the group consisting of ethenesulphonic acid, propenesulphonic acid, butenesulphonic acid, 2-sulphonomethylacrylic acid, 2-sulphonomethylmethacrylic acid, 2-sulphonomethylacrylamide, 2-sulphonomethylmethacrylamide, and combinations thereof.

33. The method of claim 30, wherein said composition, based on its total weight, comprises at least 20% by weight of at least one monomer comprising a sulphonic acid group.

34. The method of claim 26, wherein said polymerization is initiated thermally, photochemically, chemically, and/or electrochemically.

35. The method of claim 34, wherein a radical former is employed which has a water solubility of at least 0.1 g per 100 g of aqueous solution at 20° C. and pH=5.

36. The method of claim 35, wherein said radical former is selected from the group consisting of 2,2′-azobis(2-amidinopropane) dihydrochloride, 2,2′-azobis(2-methylpropionamidine) dihydrochloride, 4,4′-azobis(4-cyanovaleric acid), 2,2′-azobis(2,4-dimethyl-4-methoxypentanenitrile), 2,2′-azobis-(N,N′-diethyleneisobutylamidine) dihydrochloride, 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(2-imidazolin-2-yl)propane disulfate dihydrate, 2,2′-azobis(2-methylpropionamide) dihydrochloride, 2,2′-azobis[N-(2-carboxyethyl)-2-methylpropionamidine]tetrahydrate, 2,2′-azobis[2-(3,4,5,6-tetrahydropyrimidin-2-ylpropane]dihydrochloride, 2,2′-azobis{2-[1-(2-hydroxyethyl)-2-imidazolin-2-yl]propane}dihydrochloride, 2,2′-azobis[2-(2-imidazolin-2-yl)propane], 2,2′-azobis{2-methyl-N-[1,1-bis(hydroxymethyl)-2-hydroxyethyl]propionamide, 2,2′-azobis{2-methyl-N-[2-(1-hydroxybutyl)]propionamide} and/or 2,2′-azobis[2-methyl-N-(2-hydroxyethyl)propionamide], and combinations thereof.

37. The method of claim 34, wherein said radical former has a half-life in the range of 1 minute to 300 minutes, measured under the chosen polymerization conditions.

38. A polymer with a weight average of the degree of polymerization of more than 300, obtained by the method of claim 26.

39. The polymer of claim 38, wherein said polymer has an inherent viscosity of more than 10.0 dL/g, measured as a 0.4 wt-% solution at 25° C.

40. A composition comprising a polymer (A) and a polymer (B), wherein polymer (B) is different from polymer (A) and wherein said polymer (A) is a polymer of claim 38.

41. The composition of claim 40, wherein the weight ratio of polymer (A) to polymer (B) is in the range of from 1:1 to 10:1.

42. The composition of claim 40, comprising, based on its total weight,
a) 40.0 to 90.0% by weight of polymer (A);
b) 1.0 to 30.0% by weight of polymer (B); and
c) 0.0 to 50.0% by weight of phosphoric acid.

43. A membrane electrode assembly comprising two electrochemically active electrodes, wherein each said electrochemically active electrode is in contact with a catalyst layer and separated by a polymer electrolyte membrane, wherein said polymer electrolyte membrane comprises a polymer of claim 38.

44. The membrane electrode assembly of claim 43, wherein said polymer electrolyte membrane comprises polyazoles.

45. The membrane electrode assembly of claim 43, wherein said polymer electrolyte membrane is doped with an acid.

46. The membrane electrode assembly of claim 45, wherein said acid is phosphoric acid.

47. The membrane electrode assembly of claim 46, wherein the concentration of said phosphoric acid is at least 50% by weight.

48. The membrane electrode assembly of claim 45, wherein the degree of doping is between 3 and 50.

49. The membrane electrode assembly of claim 43, obtained by a method comprising
a) dissolving at least one alkaline polymer in an acid;
b) dissolving in an acid at least one polymer obtained by free-radical polymerization which, based on its total weight, comprises at least 80.0% by weight of ethylenically unsaturated compounds, wherein said at least one polymer comprises at least one monomer comprising a phosphonic acid group, has a weight average of the degree of polymerization of more than 300, an inherent viscosity of more than 10.0 dL/g, measured as a 0.4 wt-% solution at 25° C., and, optionally, a different polymer (B);
c) admixing the solutions from a) and b); and
d) optionally cross-linking the admixed polymers with each other.

50. The membrane electrode assembly of claim 43, obtained by a method comprising
a) dissolving at least one alkaline polymer in an acid;
b) dissolving in an acid at least one polymer obtained by free-radical polymerization which, based on its total weight, comprises at least 80.0% by weight of ethylenically unsaturated compounds, wherein said at least one polymer comprises at least one monomer comprising a sulphonic acid group, has a weight average of the degree of polymerization of more than 300, an inherent viscosity of more than 10.0 dL/g, measured as a 0.4 wt-% solution at 25° C., and, optionally, a different polymer (B);
c) admixing the solutions from a) and b); and
d) optionally cross-linking the admixed polymers with each other.

51. A fuel cell comprising at least one membrane electrode assembly of claim 43.
